(19) United States
(12) Patent Application Publication
(10) Pub. No.: US 2014/0350954 A1
(43) Pub. Date: Nov. 27, 2014

(54) System and Methods for Personalized Clinical Decision Support Tools

(71) Applicant: Ontomics, Inc., White Plains, NY (US)

(72) Inventors: Stephen Ellis, Long Island, NY (US); Omri Gottesman, New York, NY (US); Erwin Bottinger, White Plains, NY (US)

(73) Assignee: Ontomics, Inc., White Plains, NY (US)

(21) Appl. No.: 14/211,408

(22) Filed: Mar. 14, 2014

Related U.S. Application Data
(60) Provisional application No. 61/784,647, filed on Mar. 14, 2013.

(51) Int. Cl. G06F 19/00

(52) U.S. Cl. CPC G06F 19/345
USPC 705/2

(57) ABSTRACT

The use of a medical software platform to collect, normalize, and aggregate clinical data. Supports clinical care and provides research and clinical tools for institutions, healthcare providers, researchers, and patients. The invention provides a graphical interface to customize searches in the database for specified subsets of conditions, treatments or outcomes. The invention also provides a system and method for searching through clinical databases for desired terms which may provide additional information to a physician regarding patient care. Furthermore, this invention facilitates personalized medicine-based practices as relationships between genetics, personal heath data from multiple sources, disease risk and drug response can be more easily visualized and utilized for patient care and research.

### CROSS-REFERENCE

This application claims the benefit of U.S. Provisional Application No. 61/784,647, filed on Mar. 14, 2013, which is incorporated by reference herein in its entirety.

### INCORPORATION BY REFERENCE

All publications, patents, patent applications, and databases, mentioned in this specification are herein incorporated by reference to the same extent as if each individual publication, patent, or patent application was specifically and individually indicated to be incorporated by reference.

### BACKGROUND

Personalized medicine aims to optimize the healthcare provided to individuals by basing decisions about their care on all available patient data. The goal of personalized medicine is to provide the right treatment at the right time for the right patient. Since variations in an individual's clinical, genetic or other molecular data can correlate with differences in how individuals develop diseases and respond to treatment, personalized medicine has the potential to improve outcomes and reduce cost through the tailoring of healthcare to the individual.

Today, more and more of our healthcare interactions occur in the digital realm; however, little emphasis has been placed on data standards and interoperability. As a result, digital healthcare data remains locked within disparate healthcare systems and is inaccessible to the types of tools and applications that have become widespread in other industries. This organization leads to an unrealized potential of digital healthcare data, impedes the ability of researchers to make discoveries and prevents practitioners from making informed decisions tailored to a specific patient's needs.

### SUMMARY OF THE INVENTION

In some embodiments, the invention provides a method comprising: a) receiving a search term; b) identifying, based on the search term, a result clinical concept that is recognized by a first standardized ontological hierarchy; c) identifying in a second standardized ontological hierarchy a corresponding clinical concept, wherein the corresponding clinical concept has a clinical meaning that is substantively-similar to the clinical meaning of the result clinical concept; d) searching by a computer processor a database of electronic health records based on the corresponding clinical concept; e) identifying an electronic health record in the database associated with the corresponding clinical concept; and f) outputting a result.

### BRIEF DESCRIPTION OF THE FIGURES

FIG. 1 is a schematic of a clinical data collection method.

FIG. 2 is a Venn Diagram illustrating the overlap of patient data to provide a new grouping.

FIG. 3 is a block diagram illustrating a first example architecture of a computer system that can be used in connection with example embodiments of the present invention.

FIG. 4 is a diagram illustrating a computer network that can be used in connection with example embodiments of the present invention.

FIG. 5 is a block diagram illustrating a second example architecture of a computer system that can be used in connection with example embodiments of the present invention.

FIG. 6 illustrates a global network that can transmit a product of the invention.

FIG. 7 is a schematic illustrating how data can be processed from input to output in the invention.

FIG. 8 is a schematic representation of a Basic Formal Ontology (BFO).

FIG. 9 is a schematic of an ontological mapping exercise.

FIG. 10 is a schematic representation of reduction of a concern to an episode note.

FIG. 11 is a schematic displaying inter-ontology semantic conceptual mappings.

FIG. 12 is a depiction of the organization of the three highest level ontologies used by an example embodiment of the platform.

FIG. 13 is an illustration of the token repository of the platform.

FIG. 14 is a diagram illustrating an example of how patient care workflow in an EMR can be enhanced by personalized risk information interjected at appropriate points into the workflow by the invention.

FIG. 15 is an illustrative ontological tree of morbid obesity created using the Human Disease ontology.

FIG. 16 is an ontological tree of illustrative ontological parents of “hearing loss” using the Human Phenotype ontology.

FIG. 17 is an ontological tree of illustrative ontological children of “hearing loss” using the Human Phenotype ontology.

FIG. 18 illustrates an example search interface.

### DETAILED DESCRIPTION

Personalized Medicine aims to optimize the healthcare provided to individuals by basing decisions about their care on all available patient data. The goal of personalized medicine is to provide the right treatment at the right time for the right patient, as opposed to the current clinical practice of treating patients according to the best treatment option for a group. Variations in individuals' clinical, genetic or other molecular data can correlate with differences in how individuals develop diseases and respond to treatment. Thus, personalized medicine has the potential to improve outcomes and reduce cost through the tailoring of healthcare to the individual.

The invention described herein provides a health information platform that operates a clinical data utility layer and functions as a specialized Health Information Exchange (HIE). The system of the invention can communicate bi-directionally with provider Electronic Health Records (EHR), Electronic Medical Records (EMRs), Pharmacy medical records (PMR), Health Information Exchanges (HIE), patient Personal Health Record (PHR) systems, digital health applications and other sources of clinical data. The platform is made accessible to end users by an intuitive user interface that allows for graphic illustration of search terms, rather than the parsing of textual search strings.

In some embodiments, the system and methods of the invention provide processes, architectures, and applications to overcome the widespread issues associated with EHR data analysis. The invention allows for the effective use of EHR data in research and clinical care with a data structure that can be fully de-identified and HIPAA compliant, thereby providing an ideal system for sharing and aggregating medical data while protecting patient privacy.

The system of the invention provides a platform for collecting, normalizing, aggregating, using and distributing healthcare data. The system interfaces with multiple clinical data systems and clinical applications creating a bi-directional data pipeline. The invention functions as a networked repository for healthcare data and acts as a broker between institutions, patients, their data and downstream users. As a patient-centric, clinical data-rich resource, the invention is perfectly suited for the implementation of software applications designed to support personalized clinical care, such as clinical decision support, and research tools that run on top of this data structure.

Users of the invention can form a healthcare data ecosystem whereby healthcare stakeholders can develop, share, and use applications and functionalities of the invention to support clinical care and research and to share ontologically-indexed information. Users of the invention can be health care providers, such as hospitals, hospital administrators, hospital contractors, clinicians, attendants, insurance companies, governmental bodies, government agencies, researchers, nursing homes, schools, community health organizations, military institutions, and correctional institutions. Communications between users and the system of the invention, can happen according to any communication protocol including, for example, USA, Wi-Fi, Bluetooth, TCP, EnOcean™, WiMax™, ONE-NET, ANT, 6LoWPAN, Wibree, Wireless HART, and IEEE reliant protocols, such as Z-Wave™ and ZigBee™.

### Clinical Support Tools and Applications.

The disclosure provides methods and computer program products with applications in health care data management, research, coding, billing, and population genomics. A platform of the invention can utilize Clinical Logical Objects (CLOs). CLOs can be based on a combination or interaction of an attribute and a value. For example, an attribute can be a category of information useful for stratifying patients, such as phenotypic, genotypic, geographic, and socioeconomic categories. An attribute can also be a concept accessible to the lay person, such as gender, age, and blood pressure. An attribute can have a value that is temporal, for example, systolic blood pressure>140 mmHg at a point in time. A value can alternatively be enduring, for example, systolic blood pressure>140 mmHg over extended time. Thus, a CLO can be temporal or enduring, based on the underlying value. CLOs can be used to organize clinical, genomic, molecular, environmental, and patient-reported data into defined data architectures. CLOs can abstract, store and distribute relevant clinical, genomic, molecular, environmental, and patient-reported data in a useful, cross-EMR, cross-institutional, and de-identified fashion.

CLOs can be evaluated individually or collectively in groups, Clusters, or cohorts. These collections of CLOs can accelerate analysis by viewing similar data entries based on traits of interest to the user instead of viewing data entries as a collection of individual patients. Clusters of CLOs can be organized, for example, by anonymized barcodes, each representing an individual patient. Cohorts can be organized, for example, by logic operators joining records together, for example, Boolean logic.

CLOs can organize data in a specific inverted hierarchy that center the focus of information storage on a specific trait or on an individual patient. For example, a system can use the following hierarchy: Patient>Episode of Care>Chart Subject Area>Orders/Results/Observations/Notes. Such a structure can underlie the organization of Electronic Medical Records (EMRs). CLOs can also provide inverted hierarchies driven by the data incorporated into the CLO, for example: Value>Attribute>Patient>Date/time.

This inverted structure provides for rapid identification of patient cohorts who share, or are reasonably characterized by, similar CLOs. This hierarchy can accelerate data production for population analysis, quality reporting, and finding relationships in data from very different domains (such as genetic and environmental), because the data analysis is driven by clinical values contained in EMRs and PMRs, not by patient identity.

Electronic Medical Records (EMRs) can relate to records obtained and stored by a subject's doctor, clinician, insurance company, hospital and/or other facilities where a subject is a patient, or through a Personal Health Record (PHR). Electronic medical records (EMR) can comprise, for example, CAT scans, MRIs, ultrasounds, blood glucose levels, diagnoses, allergies, lab test results, EKGs, medications, daily charting, medication administration, physical assessments, admission nursing notes, nursing care plans, referrals, present and past symptoms, medical history, life style, physical examination results, tests, procedures, treatments, medications, discharges, history, diaries, problems, findings, immunizations, admission notes, on-service notes, progress notes, preoperative notes, operative notes, postoperative notes, procedure notes, delivery notes, postpartum notes, genomic data, and discharge notes.

Pharmacy medical records (PMR) can relate to records pertaining to a subject's pharmacological history. In some embodiments, pharmacological history can comprise a subject's prescription history, current prescription regimen, and side effect information, for example, dosage information, length of time a subject has been taking a prescription, and other drugs known to cause negative side effects with a subject's current prescription regimen.

Systems of the invention incorporate a broker function, which can anonymize or de-identify data to hide personal and institutional identifiers. Data can then be associated with an anonymized barcode, which associates the data with indicators of personal identity. The broker function can create a date offset from the actual date of a health care encounter, providing a higher level of privacy.

Another aspect of the invention relates to a method of providing clinical support tools and applications that facilitate the utilization of genomic sequencing data in patient care. Recent advances in technology have greatly improved understanding of the genetic contribution for many diseases, and researchers are finding links between genes, the environment, and complex genetic disorders. The invention provides clinical support tools and applications for the categorization and application of genomic data.

A large number of genetic variants have been identified in sequenced genomes, including the human genome. Variants can be of functional significance, for example, leading to a missense mutation or a non-sense mutation in a protein coding gene. Variants can be of no functional significance, such as silent mutations. Single nucleotide polymorphisms (SNPs) can be of functional significance. The system of the invention can provide a clinical data utility layer that facilitate the use of these data for clinical and research needs.

### Metadata Management.

As a patient-centric, data-rich resource, the invention is perfectly suited for the implementation of clinical applications designed to support and evaluate clinical care. Rules can be implemented across the network, at specific institutions, or at the provider or user level. This functionality could be utilized as a driver to ensure consistent practice, reporting, and billing. Clinical Decision Support (CDS) applications can be implemented so that physicians can receive recommendations of best practices at the point of decision-making, integrated seamlessly within existing clinical workflows.

The present invention contains a metadata management toolset allowing institutional data sources to define their inbound data structures and formats in order to facilitate ingestion of data from source EHR systems.

The present invention sources data from numerous institutions and settings, as well as by direct user entry. Since there is no requirement for data sources to share interoperability among their coded data, and no possibility of such interoperability natively across free text data entries, the invention provides for semantic interoperability through ontological mapping using a variety of open source and proprietary biomedical ontologies. In this way, information coded, for example, in ICD-9, ICD-10, and SNOMED can be integrated into the CLOs without regard to the coding structures in use at the data source institutions.

Because semantic ontologies are a central architectural component of the data architecture of the invention, much of the metadata provided by institutions, providers, and researchers through their respective portals is captured as ontological extensions to known ontologies, many of which are already extensions of publically available and managed semantic ontologies. The invention provides for semantic interoperability through ontological mapping using a variety of open source (public) and proprietary biomedical ontologies. This organization creates a nesting of various ontology constructs leading to internal consistency and interoperability. Relevant system requirements can include defining transfer dataset architectures, structures, and contents, mapping data structures to data constructs and architecture specific to the invention, and specifying usage of standard syntax structures (e.g. HL7, CCR).

### Data Loading and Management.

Data loading from participating institutions passes through a series of stages. Data directly ingested is loaded into a ingestion data staging warehouse of the invention after undergoing only minimal data cleansing or transformation. Direct ingestion includes any data entered directly into any of the customer-facing portals. From the clinical warehouse, data passes into the CLO Data Warehouse.

The data ingestion process receives data from enrolled institutions and stages data in the ingestion data staging warehouse. The emphasis of the ingestion process is to assure that all data from the institution is captured correctly, with complete traceability back to the source, and that data is captured in a specific way that supports mapping of data to the normalized data definitions of the invention in subsequent processing.

The system requirements can include data loading according to information provided in the metadata management function, ensuring that arriving quantitative data has a defined reference range either within the pre-defined metadata, or within the data feed itself. The data digestion process carries ingested data forward into the invention's CLO environment. The output of digestion processing is the set of Unit CLOs against which ingested data can be mapped. In some embodiments, unmapped or unrecognized data in the ingested dataset is not moved forward into CLOs. To increase quality control, the system requirements can include omitting invalid and unmapped data from digestion, normalizing quantitative data against the normalized reference ranges of the invention, and ensuring that normalized data are directly traceable back to the original source values.

Aggregation of ingested data can be driven by both ontology-based aggregation rules, as well as user-specified aggregation rules. The outputs of aggregation include arbitrarily complex CLOs and Clusters of patient data. A user can create aggregates of any level of complexity, inclusion, or comprehensiveness.

The system requirements include implementing CLO rules against newly ingested data, recognizing and making changes to existing CLOs based on newly arriving data, and updating pre-defined and existing aggregate Clusters. These rules can be created by a user, and loaded into a rules engine. The rules engine can be instructed to apply the rule whenever the rule is triggered. For example, a rule can be encoded to trigger when a new record is created, or when an existing record is updated. A rule can be activated when a specified term, or an ontological equivalent thereof, is entered into a record, or used as a search term. Once activated, the rule can apply a result, for example, sending an alert to the user, sending an alert system-wide, preventing access, preventing entry of a record, preventing update of a record, denying access, creating a report, providing clinical support guidance, or requesting emergency assistance.

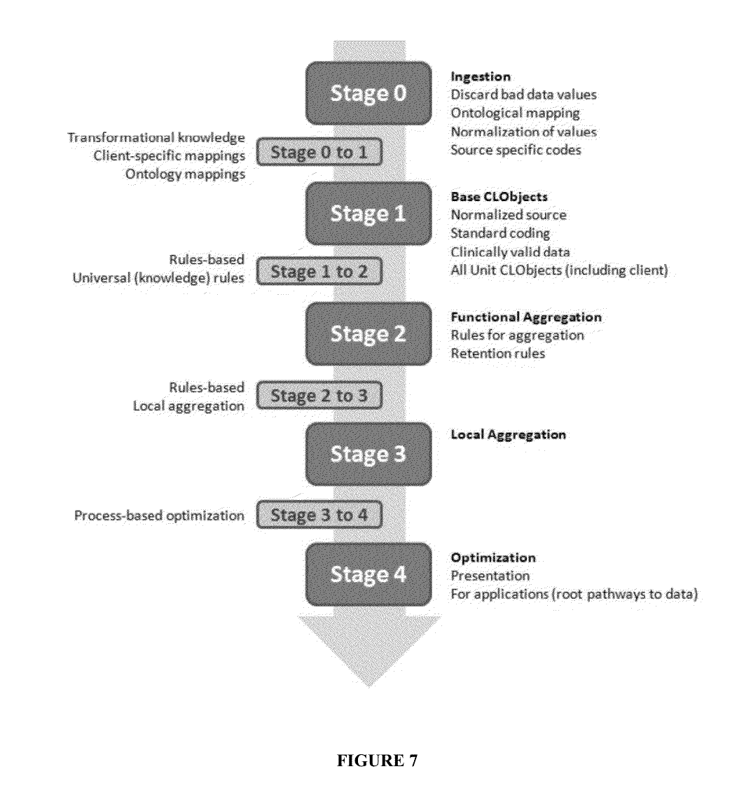

FIG. 7 provides an illustrative example of the stages described above. As depicted in FIG. 7, data from institutions, providers, and researchers passes through a series of stages before final output. At stage 0, the data are ingested. Bad data values are discarded and those that remain are normalized and sourced to specific codes, thereby creating the first stage of ontological mapping. Between stages 0 and 1, transformational knowledge from the system is applied to map the data to data definitions for subsequent processing into CLOs. At stage 1, objectification of the data begins, whereby ingested data is converted into sets of Unit CLOs. At stages 2 and 3, aggregation of the CLOs begins. Data aggregation can be guided by not only ontology-based aggregation rules, but also by user-defined aggregation rules. The data after aggregation is presented as CLOs and Clusters. The final stage in the data management pathway is optimization. At this stage, the program converts the created CLOs and Clusters into forms that are useable for the various functions and tools of the platform. This procedure is normalized and reproduced with high fidelity to allow for the data to be organized according to common access paths, ultimately optimizing performance of the system for end-users.

### Aggregation Workbench.

The Aggregation Workbench of the invention allows stakeholders to define new data rules beyond those provided in the baseline. Users can combine base data structures into Cluster aggregations. These aggregations can be customer defined, and can take advantage of ontological relationships and knowledge available in the workbench. For example, to aggregate patients between the ages of 16 and 18, a user can define an aggregation function that pools the Unit CLOs defining patients that are 16, 17, or 18 years of age. This action creates a Cluster for patients that are 16, 17, or 18 years of age.

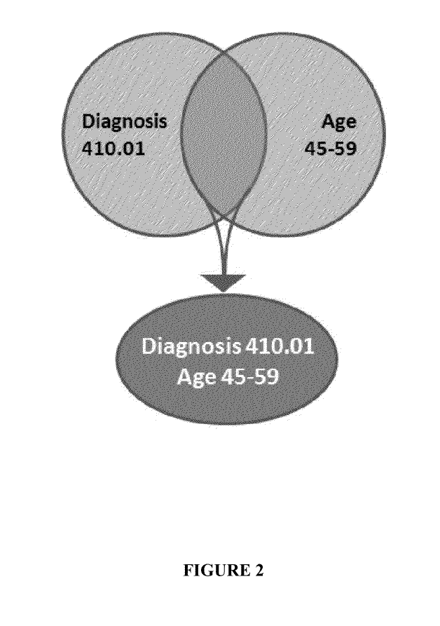

FIG. 2 provides an illustrative example of base data structures created from user-defined CLOs being used to create new Cluster aggregations. For example, if a user is searching for patients with a specific diagnosis (410.01) falling within a specific age range (45-59), the user defines an aggregation function that pools patients defined by CLOs encompassing the specific diagnosis and age range. This strategy creates the Cluster of patients that have the diagnosis 410.01 and are between 45 and 59 years of age.

### Interface.

The Clinical Decision Support (CDS) toolset allows the invention to interact with, either synchronously or asynchronously, an institution's electronic health record system (EHR) at the point of care in order to enhance the value of point-of-care clinical data using the knowledge bases and data available in the CLO Warehouse. The system requirements can include application of various clinical and research-based criteria, and support for known or research-defined guidelines. The invention can provide alerts to end users in real-time, while patients are still present or can deliver alerts to end users though other mechanisms including email and SMS messaging at other times. The system functions and features include support for multiple common synchronous and asynchronous protocols and integration with existing commonly implemented EMR applications at the point of care.

A Patients Like This (PLT) toolset of the invention comprises a suite of applications that allow end users to access the CLO Warehouse in order to identify treatment patterns and related outcomes among extensive patient clinical populations within the warehouse, to identify similar patients to those presenting at the point-of-care, to author or implement Clinical Decision Support (CDS) Rules or for research applications. A grouping of patients characterized by specified values can be generated in a user interface, and narrowed or expanded to obtain the desired scope of records. Searching is then possible within the grouping of Patients Like This to learn information that can be relevant to others with similar data. For example, when providing therapy to a patient with a certain indication, a physician can search for Patients Like This to learn what therapies are currently being used for the indication in the physician's hospital. This tool also allows rapid collection of research information that is conveniently limited to exactly the types of patients that the user seeks. A user can also generate a rule that applies precisely to Patients Like This. The system requirements can include requesting provider profiles of known clinical observations, requesting provider weighting of known factors, and analyzing CLOs and Clusters to retrieve similar cases and data.

A Query Tool of the invention allows users to access CLO data and Clusters, in varying levels of identification according to their IRB profile or other regulatory approval, allowing the exploration or definition of cohorts of interest. The query tool can exist as a convenient graphic interface, which allows a user to illustrate search terms by clicking on search tools, such as a CLO search window, and positioning the search tools on a display as is convenient for building the search. Many search tools can be positioned on the screen and reorganized as the user desires. Search terms can be entered into the search tools, and the tools can be connected by logical, sequence, date or time operators. The connections can be made by graphically illustration connections, for example, by drawing lines, graphs, or geometric figures on the display. The pattern of connections implies the relationships among the search terms. The user can enter operators, for example, Boolean logic operators, to specify the desired relationships among the search terms. A computer system running the program determines the search strategy by interpreting the graphic relationships among the search terms and operators. The search is then performed based on the query entered, without the need for the user to construct a complicated textual search string or procedural search logic or code.

The system requirements can include identifying target populations or cohorts, applying patient demographic and geographic filters, and abstracting of complexities through CLO models. An additional requirement can be time-sensitivity to relative events and order of data elements. The system functions and features can include integration of complex query criteria into Clusters and use of sophisticated abilities using high degrees of query specificity.

A Curation & Redaction toolset of the invention allows authorized users to add notations and connections among their data elements manually in order to enhance the data and tailor information to the user's purpose. The system requirements can include addition of semantic and taxonomic datasets or ontologies and the ability to set use-case-based thresholds for necessary redaction of private data. The system functions and features can include natural language processing capabilities for analyzing free text materials.

A Data Delivery toolset of the invention allows authorized users to define and receive datasets from the invention that can then be used more locally in client-specific tools and environments. The system requirements can include flexible data delivery mechanisms and standardized data conversions to target frameworks upon delivery. The system functions and features can include standardized exchanges using known standards and formats.

A Dashboard & Scorecard toolset of the invention can provide visibility into the environment of the invention to monitor and control data and processes on an on-going basis. The system requirements can include customer and data-focused rates and forms of usage and financial tracking and administration. The system functions and features can include querying of control data through both push and pull mechanisms.

### Internal Controls.

An Honest Broker function of the invention provides the essential functionality needed to securely hide identifiers for patients, providers, and institutions; translating each into token identifiers to be used within all CLO data structures. In addition to identifier anonymization, the broker provides an anchor date offset from which all dates and times in the CLO structures are pseudonymized.

Table 1

Honest token ID-to-Token Mapping. This table shows that for an ID of the ID type MRN for Hospital A, the ID is assigned Token 356749 with an offset date of 18 Aug. 2004. This token identifier can be used within all CLO data structures.

TABLE 1

| Institution | ID Type | ID | Token | Ref. Time |
|---|---|---|---|---|
| Hospital A | MRN | 1234 | 356749 | 18 Aug 2004 |
| Hospital A | MRN | 6789 | 162453 | 21 Dec 2007 |
| Hospital A | PROV. | 54321 | 245376 | 16 Apr 2010 |
| Hospital A | INST. | 987 | 974536 | 14 May 2002 |
| Hospital B | MRN | 4567 | 542785 | 12 Jun 1999 |
| Hospital B | PROV. | 98765 | 983657 | 14 Dec 2001 |

The system requirements can include alias alignment, identifier merging (A34), collision management, institutional notifications, and synonyms. Additionally, the system requirements can include assignment of a surrogate identifier for each enrolling participant and mapping of a surrogate identifier to each distinct or local identifier in data sources. The system functions and features can include orphan processing and controls.

The process and quality management of the invention provides tools and functions aimed at assuring that the data managed within and across the platform helps support high-performance within and among participating organizations. The system requirements can include proactive pursuing of appropriate care for patients, population management profiling, patient/case management across organizations, benchmark care guidelines mapping & reporting, and support for accountable care requirements. The system functions and features can include cross-organizational patient and provider tracking controls.

A Revenue Management Tools functionality of the invention can provide visibility and controls into the financial pricing, provision, and compensation of organizations, providers, and participating patients. The system requirements can include internal accounting, usage statistics, client payments, and stakeholder disbursements. The system functions and features can include implementation of encoded contracts and pricing mechanisms.

### Customer-Facing Portals.

The customer-facing portals are the outward face of the invention to all organizational stakeholders. Each class of stakeholders, for example, institutions, providers, researchers, and patients, has their own portal interface through which services are provided. All portals share services, options, and data access, constrained by their access authorizations.

An Institutional Portal of the invention can be a web-based interface for healthcare and research institutions to interact with services of the invention. This portal can be the main coordination point between the invention and participating organizations, with most other provider, patient, and customer services taking place within the context of an institutional relationship established and documented in this portal. Participating institutions provide access to their EHR and other data sources, and coordinate technical contacts for establishing appropriate data transfer protocols.

Non-limiting examples of services and commands available in this portal include the following. Enroll as Institution: Institutions, from academic medical centers, to small clinical practices, to for-profit medical and health research companies can enroll in the invention as participating institutions. These enrollments serve as the anchor points against which providers, patients, and researchers are contacted. Register Data Sources: Enrolled institutions can provide information about their patient data repositories to start the process of integrating their EMR or EHR applications data into the environment of the invention. Provide Metadata: Institutions that register data sources can provide sufficient metadata about those sources so that data transfers between those systems and the invention can be handled and interpreted correctly. Name Providers: Individual providers with enrolled institutions can be identified in order to facilitate their individual registration into, and use of, the functions and capabilities of the invention. Define Rule Makers: Individuals at each institution, whether named as providers at those institutions or not, can be identified as rule makers with respect to policy setting and execution of agreements between the institution and the invention. Release Patient Data: Institutions can release patient data to the invention once patients have granted permission for them to do so.

A Provider Portal of the invention is a web-based interface for healthcare providers to interact with services of the invention. Most interactions include care-related activities, including point-of-care decision support and alert message activity, or rules and preference definition activities as a precursor to such activities. Providers (e.g., physicians, pharmacists) represent a principal provision of care stakeholder market for the invention. Providers can interact with the invention for the purpose of taking advantage of the diagnostic and informative power of its knowledge base and tools.

Non-limiting examples of services and commands available in this portal include the following. Enroll as Provider: Providers who have been named by enrolling institutions can enroll in the services of the invention. Invite Patients: Providers can provide lists of their patients who they would like invited to participate in the invention's crowdsource ecosystem. Define Rules: Providers can define their own rules for engaging with the invention from among service options and offerings available and growing over time. Permissioning: Providers can grant permission for any or all the functions of the invention to be active within their practice and patient visits. Schedule Patient Visit: The scheduling of patient visits to the provider creates an opportunity to review and update patient information contained in the invention. Conduct Patient Visit: Providers can be visited by their enrolled patients from time-to-time, creating the opportunity to add additional data about those patients. ADC/IDC: Clinical data at the point of care can be captured through either integrated or asynchronous data capture technologies that interact directly with registered provider applications at the institution. Receive Alerts & Notifications: Providers receive contextually-significant alerts and notifications at the point of care from the invention. Many of these messages are available to providers asynchronously from patient visits, with growth toward real-time messaging as the technologies mature. Review Similar Cases: Providers can query the invention for clinical similarities between a patient being seen at the point of care and other patients defined in the invention (PLT).

A Patient Portal of the invention can be a web-based interface for patients to interact with its services. While patients can periodically find the invention on their own, they are most likely to access the portal in response to an invitation from one or more of their healthcare provider institutions. The intuitive user interface makes the process easy for patients so that they want to participate in the broadest possible range of services and activities; including providing their own healthcare data, consenting to participate in data collection through all of their healthcare providers, and agreeing to participate in any appropriate recontacting services offered on behalf of institutional clients.

Patients interested in the services of the invention can interact directly with its toolset, typically only after a baseline of identity data is in the knowledge base of the invention as a result of a provider interaction. Patients control their data, so even in situations where a provider is using the knowledge base and tools to provide care, each patient can grant permission for that provider to do so. Patients also independently use the tools of the invention directly to enter and maintain their own demographic and health data (molecular, demographic, environmental, phenotypic, or genotypic), as well as linkages to their own Personal Health Records (PHRs) stored or maintained outside of any of the invention's participating institutions or providers.

Non-limiting examples of services and commands available in this portal include the following. Receive Invitations: Patients can receive invitations to enroll based on their use of providers whose institutions are enrolled in the invention. Enroll as Participant: Individuals can enroll in the services of the invention as participants, either directly or as a result of an invitation offered by an enrolled institution. Provide Preferences: Enrolled participants can provide and maintain their preferences for much of the functional and data interactions that take place between the invention and related providers. The system of the invention can be largely driven and controlled by patient preferences. Enroll in Projects/Studies: Patients can choose to enroll in specific research studies to which they have been invited because they meet the criteria for inclusion in such studies, and they have previously indicated a willingness to be contacted for such purposes. Receive Summarized Results Patients can be provided with summarized results from studies or projects in which they have chosen to participate. Grant Permissions: Patients can provide specific permissions for the data that can be exchanged and managed by the invention and its enrolled providers. Such permission leaves control in the hands of the patients, and benefits from a deep level of granularity so that patients retain full control over who sees their data, and at what level of detail. Manage Personal Data: Patients can provide and maintain their personal information in the platform, including the reconciliation of conflicts and data collisions that might occur as a result of consolidating patient information from multiple participating institutions. Visit Provider: As patients visit their providers, those visits can interact with the invention in ways that might be visible to the patient, or that might remain behind the scenes. Receive Notifications: The invention can generate notifications of interest to enrolled patients. Provide & Review Data: Patients can provide data directly to the invention, and have an ability to review all of their data. Participate in Mechanisms: Some of the data that patients provide directly can be in response to mechanisms provided by enrolled institutions, either providers or researchers. Network with Participants: The invention can provide a limited social networking capability for enrolled patients, providers, and researchers. Receive Compensation: Patients can receive compensation for the identified use of their data under the profit sharing agreement of the invention as well as directly for participating in re-contacting activities.

### Research Portal.

A Research Portal of the invention can be a web-based interface for healthcare-related analysts and researchers—from both not-for-profit and for-profit sectors—to interact with services. The portal allows access to cohort and population analysis services, as well as the ability to define and access datasets, at various levels of identification based upon IRB status—for further study outside of the environment of the invention.

Researchers represent another principal stakeholder in the products and services of the invention. Unlike providers who are using the invention for the provision of care, researchers are using the data and tools as part of their own study methodologies. Researchers can be associated with institutions and research teams on both short and long-term bases.

Non-limiting examples of services and commands available in this portal include the following. Enroll as Researcher: Researchers who have been named by enrolling institutions are able to enroll in the services of the invention. Manage Consortia: Individual researchers who work with researchers at unaffiliated institutions can manage those relationships on a peer-to-peer basis, or at the project/study level. Register Projects/Studies: Researchers can register their projects, starting the process of obtaining IRB approval to use the services of the platform in their research. Provide Criteria Researchers can provide inclusion and exclusion criteria for their projects or studies in a process that closely mimics IRB data access definitions. Identify Cohorts: Researchers can define cohort definitions and search for research and control cohorts in the data of the invention. Obtain Datasets Researchers can receive datasets from the invention for their IRB approved studies for patients who have consented to participate in those studies. Define Rules: Providers can maintain the rules that govern their data inputs and outputs for information related to their studies. Curate Data Researchers can curate their own data in the system of the invention. Receive Notifications: Based on their own predefined rules, the system of the invention can provide notifications and alerts to researchers. Receive Hypotheses: As the continuous analysis of data in the invention is carried out, certain patterns can match researcher-provided criteria to generate working hypotheses from correlations spotted in the data. Review Hypothetical Cohorts: By identifying patient criteria, researchers can see profiles of working cohorts that match their stated case criteria, providing a hypothetical version of the provider-oriented PLT capability.

### Processing Tools.

Utilization Monitoring within the platform provides functionality to monitor service levels in the various subsystems of the invention to support any tuning and revision required to maintain effective and high-performance operations of the invention's environment and toolsets. The system requirements can include internal tracking and monitoring of loads, requests, queries, an data downloads, and tracking of who is using what functions and features, and how often. The system functions and features can include security and privacy auditing.

### Messaging and Workflow Engine.

The Messaging and Workflow functions control the sequencing, prioritization, and tracking of messages back-and-forth between the platform and participating services, ensuring end-to-end continuity of all workflow interactions and message signaling.

The communication of both data and advisory messages between the portal and participant datasets is central to the mission of the portal. Controlling these workflows in order to track all data coming into or out of the invention benefits from identifying process checkpoints where logs can be established and monitored by support personnel to ensure the completeness and validity of all workflows.

The system requirements include initiation, tracking, and termination of interactive sessions with provider EMRs, prioritization of all generated messages, production of messages consistent with participant stated preferences, aging of notifications and alerts that have been generated, and resending of certain high priority messages that lack anticipated action or response. The system functions and features can include monitoring of data sourcing staging and loads and controlling for message forwarding after session interruptions.

An authentication functionality of the invention ensures that all users and participants using the functions and services of the invention are properly identified and authenticated at each point of interaction. Additionally, state-of-the-art controls can surround all functional interactions.

The system requirements can include a provision of single sign-on capability through multiple interfaces. The system functions and features can include integration of social media models and frameworks and standards.

### Administrative Capabilities.

The data administrators of the platform can be responsible for the definition and maintenance of the data standards, conventions, and structures. Non-limiting examples of services and commands available in this capacity include the following. Model Data: Data administrators can logically model data in the system of the invention to assure that data from multiple sources is properly integrated and internalized. Update Metadata: The metadata that all stakeholders rely upon to use the services of the invention can be constantly monitored and maintained based on on-going changes and additions to the data as a whole, and of rules being provided by different stakeholders. Facilitate Governance: The operating parameters of the operations of the invention are subject to high-level governance decision-making Curate Data: Based upon data modeling, rules changes, or simply data exceptions, the data administrators can periodically curate data being managed within the network. Manage Ontologies: Because available semantic ontologies are not yet perfected in most cases, individual entries and mappings can be mapped into the platform; particularly in the resolution of conflicts that arise across multiple data sources and ontologies. Control Data Quality: Data administrators can monitor and control the quality of data in the invention, and take necessary steps to improve or correct data quality issues as they arise.

### System Support.

The support team of the invention is responsible for the day-to-day operation of the portal, and all client contacts in the service arena. Non-limiting examples of services and commands available in this capacity include the following. Implement Policy: Support team members implement the various policies invoked by the governance body, many requiring programmatic implementation in the system of the invention. Studies: Projects and studies require implementation as they are defined and managed through their lifecycle, with data and security changes required over time. Engage Users: Users of the invention can require support from time to time, particularly the relatively public users represented by patients. Manage Loads: Data loads from a variety of systems and applications can require management through the registration, metadata, and ETL processes. Manage Notices: Alerts and notification in the system can require management and intervention as they age over time, or become obsolete with age. Manage Datasets: Datasets created for researchers are likely to be subject to controls that can be managed beyond the technical boundaries of the platform. Monitor Performance: Performance of processes in the invention can be monitored to assure adequate service levels are delivered to all stakeholders, particularly the more processing intensive analytical functions of the system that require scalabilty over time.

### Controls Audit.

Auditors of the invention are responsible for ensuring that controls are well established through all products and services and that all auditability clauses of agreements among the portal stakeholders of the invention are supportable with the data available within the Portal. Non-limiting examples of services and commands available in this capacity include the following. Evaluate Controls: Auditors can evaluate the various controls that are in place in the platform. Evaluate Load Data Auditors can evaluate that all data loads are in accordance with appropriate data usage agreements and granted permissions. Evaluate Access Data: Auditors can evaluate the appropriateness of all data access in the system. Evaluate Quality Data: Auditors can evaluate the quality of all data in the system, as well as related cleanup conventions.

### HIPAA Officer.

The HIPAA Officer of the platform is responsible for the HIPAA compliance of all portal products and services, and plays a role in attesting to the HIPAA compliance of all the Portal participants of the invention. Non-limiting examples of services and commands available in this capacity include the following. Set Policy: Control parameters for the invention can be controlled by policies set at the system level for HIPAA compliance. Evaluate Agreements: Data usage agreements and project planning can be reviewed for compliance. Monitor Usage: All data access in the invention is subject to monitoring and review. Monitor Compliance: The overall compliance of the systems of the invention can be monitored for compliance to all agreement provisions and control policies.

### Data Governance.

The data governance function of the invention provides for strategic control of Portal products and services over time, including decisions related to deploying standardized and client-exceptional functionality and services. Non-limiting examples of services and commands available in this capacity include the following. Set Policy: The governance body of the invention sets operational policies that are implemented by a series of controls throughout the platform (e.g., Reference Events). Prioritize Services: The governance body sets priorities for the implementation and roll-out of extending features of the invention over time. Monitor Exceptions: The governance body monitors and evaluates all exceptions to anticipated operational patterns and agreements, seeking opportunities for product and service improvements.

### Ontology Management.

Ontologies embody clinical and operational knowledge that is defined and maintained by the broader practitioner community, allowing the present invention to be based on the broadest range of knowledge and practice without requiring that such knowledge be specifically curated by the invention itself Ontologies provide a level of semantic rigor that allows such knowledge to be manipulated by the present software in such ways that only valid connections and conclusions are systematically derived.

Various ontologies can be used by the platform in searching and data recording. A record can be maintained or searched in one or multiple ontologies. The platform can maintain a mapping module for tracking the ontological mapping of terms across multiple different ontologies. The map can be updated internally or by external contributors. The map provides a fast and convenient resource by which the platform can quickly search laterally and vertically to find terms with substantively-similar, or substantively-identical, clinical meanings. The mapping module also facilitates communication across institutions that use disparate ontologies, by acting as a translator and allowing each institution to search and understand the other's data.

### Open Biomedical Ontology (OBO).

Ontologies are representations of knowledge that are relevant to a specific domain. The specified domain uses a shared vocabulary to denote the properties and relationships between different aspects of knowledge contained within the domain. The domain can embody clinical and operational knowledge that is relevant to the healthcare practitioner community. To account for the various semantics used by different institutions and researchers, the platform uses a broad ontology to encompass the greatest range of knowledge and practice. The platform can use, for example, the Open Biomedical Ontologies (OBO) system to manage its ontological mapping. The OBO standard defines a set of principles for using three other ontological management languages: XML, RDF, and OWL. OBO adds additional rigor for the interoperability and compatibility of multiple ontologies allowing for internal consistency and external compatibility.

Rigorous semantic ontologies have been developed using the OWL standard, an advancement on the earlier RDF standard that adapted XML constructs to ontology development. As these languages have evolved, they have been adding specific tagging features that allow semantic knowledge to be represented in an increasingly rigorous way. The OBO standard—not a language revision, but a set of principles for using those languages—adds additional rigor regarding the interoperability and compatibility of multiple ontologies. An OBO-compliant ontology can be internally consistent while also rigorously interoperable with other OBO-compliant ontologies. No two OBO-compliant ontologies are likely to contradict each other, nor are they likely to attempt to define the same concepts. Their internal relations can be externally defined in the OBO Relations Ontology so that the same relationships across the ontologies can have similar meanings.

A central control in a OBO-compliant ontology is the requirement that all relationships defined in an OBO-compliant ontology ordinarily make use of relationships defined in the OBO Relations Ontology (RO). The RO addresses one of the biggest risk in navigating knowledge bases using ontologies, that the semantic meaning of relationships in different ontologies using the same name could agree imprecisely, and that conclusions drawn from inferring connections across such relationships can be misleading or incorrect. Relationships can be specified using a variety of descriptors, which can be further subdivided into more precise descriptors, if necessary.

By requiring all ontologies to share the same base of available relationships, different ontologies can be navigated logically across those ontologies without the risk of hidden semantic shifts causing threads of logic in the evaluation of data to become incorrect.

Another strong control in an OBO-compliant ontology is the requirement that all resources defined in the ontology be ultimately traceable to one of the constructs defined in the Basic Formal Ontology (BFO), an ontology defined precisely to serve as an upper-level ontology that anchors resources across the knowledge continuum. The basic ontology splits the world into continuants—things that persist over time—and occurrents—happenings in or of time. Continuants participate in occurrents that, in turn, modify the dependent properties of those continuants.

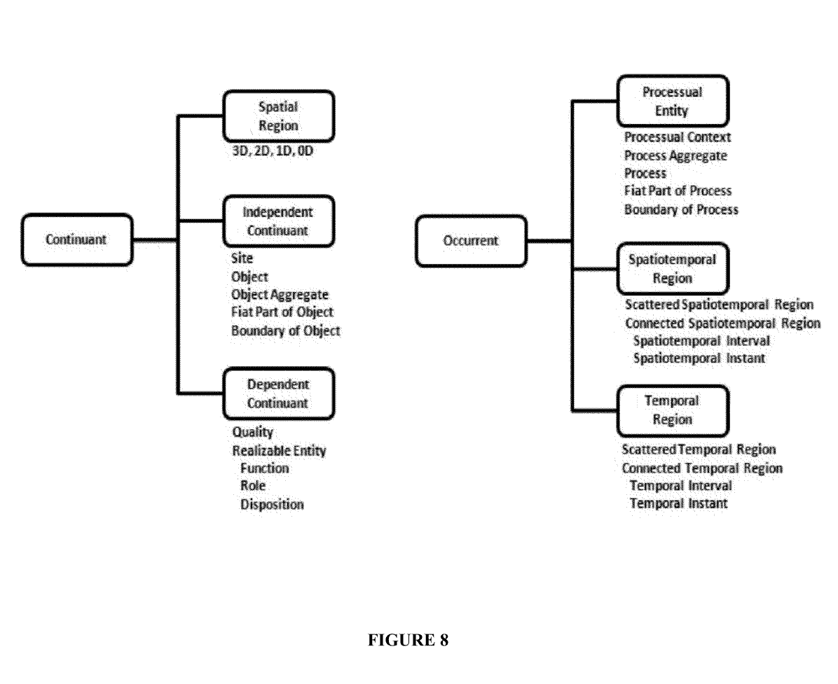

FIG. 8 is a visual representation of a BFO divided into continuants, those entities which endure over time, and occurrents, those entities which do not exist in full at a single point in time. The continuants are further subdivided into spatial region, independent continuants, and dependent continuants. The spatial region subdivision encompasses dimensional entities that endure over time. Independent continuants are those entities that can exist without the support of others, whereas dependent continuants require support in order to exist. The occurrents are divided into processual entities, spatiotemporal regions, and temporal regions. Processual entities are processes that unfold over successive periods of time. A spatiotemporal region is an entity that exists as a function of space and time, and can either be an interval, occurring over time, or an instant, occurring only at a specific point in time. A temporal region is an entity that exists as a function of time only.

### Ontological Mapping.

Ontological mapping is a core component of the definition of CLOs in the invention. Because the data represented in CLOs represents instances of real world clinical information, mapping is essential to get from the types of constructs represented in clinical ontologies and the real-world instances of data that map to those types of classifications.

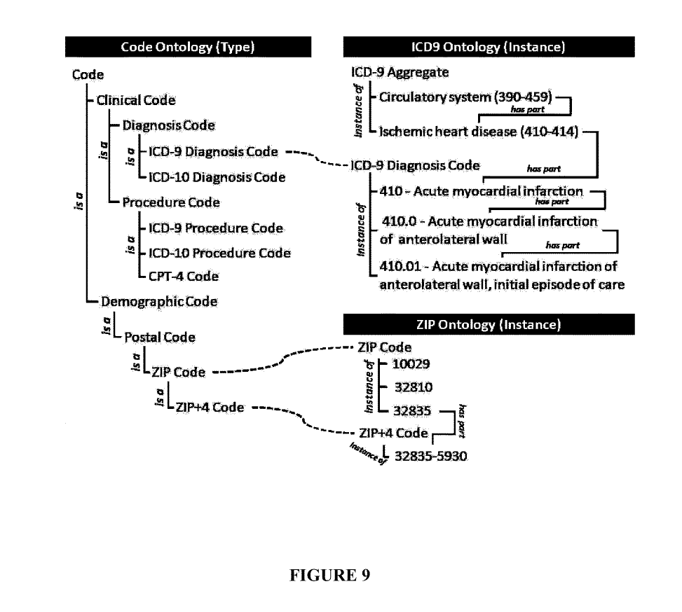

An example of such a mapping exercise is illustrated in FIG. 9. The left pane of the figure illustrates ontological entries that define various types of codes that occur within data records. Clinical codes are differentiated from demographic codes. Within the realm of clinical codes, diagnosis codes are delineated into ICD-9 and ICD-10 diagnosis codes. The relationship used to define these relationships (“is a”) is among the most critical relationships used in typing ontologies. The mapping illustrates that ICD-9 and ICD-10 are diagnosis codes with dissimilar meanings; thus, their lists of instances are disjointed.

The right pane of FIG. 9 illustrates some of the instances that can be defined against the typing ontology in the left pane. The ICD-9 Ontology on the right pane defines instances of constructs represented in the typing ontology on the left pane. Codes 410, 410.0, and 410.01 are all provided as instances of the ICD-9 Diagnosis Code. The relationships among the instances are illustrated, for example, by 410.01 being defined as a part of 410.0, which is defined as a part of 410. Through such “part of” relationships, a diagnosis of 410.0 or 410.01 is also a diagnosis of 410, but the reverse need not be true.

Table 2 provides a non-limiting list of ontological hierarchies suitable for use with the platform of the invention.

TABLE 2
Example Listing of Available Biomedical Ontologies
Ontology Name

Anatomical Entity Ontology (AEO)
BioAssay Ontology (BAO)
Bioinformatics operations, types of data, data formats and topics (EDAM)
Biological imaging methods (FBbi)
Bleeding History Phenotype (BHO)
Cardiac Electrophysiology Ontology (EP)
Chemical entities of biological interest (CHEBI)
Chemical Information Ontology (CHEMINF)
Clinical Measurement Ontology (CMO)
Current Procedural Terminology (CPT)
Diagnostic Ontology (DiagnosticOnt)
Environment Ontology (ENVO)
eVOC (Expressed Sequence Annotation for Humans) (EV)
Family Health History Ontology (FHHO)
FDA Medical Devices (2010) (FDA-MedDevice)
Gene Ontology (GO)
Gene Regulation Ontology (GRO)
General Formal Ontology (GFO)
Health Level Seven (HL7)
HEALTH_INDICATORS (HLTH_INDICS)
Human disease ontology (DOID)
Human Phenotype Ontology (HP)
Infectious Disease Ontology (IDO)
Influenza Ontology (FLU)
International Classification for Nursing Practice (ICNP)
International Classification of Diseases (ICD9CM)
Logical Observation Identifier Names and Codes (LNC)
Medical Subject Headings (MSH)
Nursing Interventions Classification (NIC) (NIC)
Ontology for Biomedical Investigations (OBI)
Ontology for General Medical Science (OGMS)
Ontology of Clinical Research (OCRe) (OCRe)
Ontology of Data Mining (OntoDM)
Phenotype Fragment Ontology (PFO)
Protein Ontology (pro-ont)
Protein-protein interaction (MI)
SNOMED Clinical Terms (SNOMEDCT)
Symptom Ontology (SYMP)
Systems Biology (SBO)
Units of measurement (UO)
WHO Adverse Reaction Terminology (WHO)

### Ingestion Data Staging Warehouse.

The ingestion data staging warehouse of the invention is the intake storage for all data arriving from enrolled institutions and is a large-scale ingestion data staging warehouse. This aspect serves as the workspace for semantic mapping, and as a source dataset for the creation and loading of CLOs.

Data in the ingestion data staging warehouse can be maintained in the form of the semantic instances in the ontologies contained in the invention, and so the further processing of data into CLOs involves mapping incoming instance data to the semantic types represented in these ontologies so that the semantic relationships contained in those ontologies can be used to refine and group data into CLOs, which are information entities ontologically. Non-limiting examples of data-to-type mapping include: Person as Independent Continuant (Object); Patient as Dependent Continuant (Role); Provider as Dependent Continuant (Role); Age as Dependent Continuant (Quality); Systolic Blood Pressure as Dependent Continuant (Quality); Office Visit as Processual Context; Patient participates in Office Visit; Provider participates in Office Visit; Age inheres in Person; and Systolic Blood Pressure inheres in Patient. Such semantic mapping, along with data normalization, provides CLOs useful in the platform.

### CLO Data Warehouse.

The CLO Data Warehouse of the platform contains the pre-digested and normalized CLOs and Clusters grouped into recognized cohorts that result from the overall objectification process. This structure can be tuned for high-performance queries in support of further research, providing a foundation for all data functionality across the platform.

### Security/Authentication.

User IDs and passwords can be required for participants to access the invention portal capabilities. These access credentials can be highly controlled and subject to fairly rigorous update and access restrictions. As a repository of data from across institutions and individuals, the capability to authenticate any portal user for the purpose of access control and functional authorization can be optimized to improve patient privacy. The system requirements can include user authentication using a unique identifier and password, role-based access to allowed functions and features, and account expiration from inactivity or abuse. The system functions and features can include supporting password reminders and periodic forced changes and allowing institutions to rescind authorizations from providers and researchers.

### User Training and Support.

The invention can be used by a variety of users, each with different responsibilities and levels of expertise in system functions. TABLE 3 outlines the different types of users expected to use the system.

TABLE 3
User Group Usage Patterns

| | | Expertise |
|---|---|---|
| User Group | Expected Usage | Level |
| Patients | Heavy use during enrollment period, | Novice |
| | followed by only periodic use during | |
| | episodes of illness or care | |
| Providers | Periodic to daily use depending upon | Intermediate |
| | the proportion of patients enrolled | |
| Researchers | Periodic to frequent use depending | Intermediate |
| | upon research project penetration. | |
| Staff | Continual use as administrators of data | Expert |
| | and operators of all analytics and | |
| | communication engines. | |

### Operational Problem Resolution.

Users of any portal can experience problems in utilizing portal interfaces and tools, and so some form of user support is needed in order to resolve issues and maintain appropriate service levels. This service is particularly important in maintaining patient participation. Such capabilities can include instructional screens and FAQs, video chat support & tutorials, and upload connectivity tools.

The portal design includes numerous functions and reports for enhancing operational performance, which can occur at regularly scheduled times and intervals. Non-liming examples of control activities include standard data base backup and related controls, user security administration and support, report scheduling and distribution, coordination for e-mail and mobile service integration, and system table and tool maintenance.

To support maximum desired operational transparency, the functions of the invention can support a broad range of audit and regulatory monitoring capabilities in support of numerous stakeholder requirements. The system features can include logging of administrative and consenting functions, logging of queries and dataset downloads, and logging of all message traffic into and out of the invention.

The functions of the invention can provide for visible and complete quality control of all data handling and consenting operations. The system features can include quantitative tracking of all loaded data elements, validation of inbound data types, including range and domain, control of counts and contains totals of all data feeds, and acknowledgement message controls for all outbound traffic. The platform can support message traffic using all standard and current versions of the Health Level 7 communication standard and reference model.

### Platform Curator.

The platform curator is a suite of tools that allow metadata needed to initiate, load, and manage the data of the platform to be defined, derived, or loaded, along with a set of internal quality assurance tools for validating and optimizing metadata definitions. The curator attempts to maximize the level to which curation of data and messages, including the mapping and alignment of data to a collection of semantic ontologies, which can be accomplished automatically with minimal human analytic intervention required. This feature allows data sources being incorporated into the platform to be treated as configurable rather than requiring the loading of each new data source to require its own hard-coded implementation after intensive analytic effort.

The curator of the platform contains various function components. Non-limiting examples of services and commands available in this capacity include the following. Message Mapper: Used to define metadata for new or changing inbound message types. This component is used by the platform support staff to define and map data into the system by structurally decomposing the definition of the messages into fragments that can be discretely mapped to the Conceptual and Functional CLOs defined to the platform. Token Manager: Used to identify data, the privacy of which needs to be protected in the platform. Any data that has been mapped, either directly or indirectly, to the Centrally Registered Identifier (CRID) in the Information Artifact Ontology can be protected, as well as any additional data explicitly tagged as such by the platform support staff. Ontology Loader: Used to define, load, and maintain external ontologies as conceptual CLOs in the platform, including impact analysis and configuration reporting as elements in ontologies change that can impact functional or concrete CLO mappings or instances. Ontology Extender: Used to define and maintain local properties of ontologies that have been loaded by the Ontology Loader, or through mapping and processing of source messages. This function maintains the internal relationship ontology that drives the Tokenizer and Scaffold Navigator capabilities. Ontology Mapper: Used to classify and map relationships among Conceptual and Functional CLOs in the abstract, as well as looking at how message constructs (i.e., ICEs, IQEs) have been mapped to concepts. Message-to-ontology and inter-ontology inconsistencies can be identified and resolved, including those originating in collisions during ontology loading and maintenance. Instance Manager: Used to manage the instances of concepts that might be subject to maintenance by the data sources from which they have been received, particularly tokenized constructs (e.g. patient merges, encounter moves). Processing includes tracking and resolving natural source keys that have not been curated as unique and that arrive in source data associated with more than one uniquely curated key. Schema Builder Used to infer the needed content of data structures to be derived from source messages that have been mapped to CLOs. This includes data structures for concrete CLOs, as well as for any outbound messages that become part of the platform in the future. Scaffold Navigator: Used to allow queries written against one semantic ontology to be extended through to other ontologies to which concepts have been appropriately mapped.

### Message Mapper.

The Message Mapper is used to define metadata for new or changing inbound message types. This component is used by the platform support staff to define and map data into the system by structurally decomposing the definition of the messages into fragments that can be discretely mapped to the Conceptual and Functional CLOs defined to the platform.

A value of the curation mapper is to maximize the portions of each new message that can be mapped automatically from structure and inferences available in the message definition or example corpus. Ideally, a curator need only be concerned with exceptions that occur during an otherwise automatic process. Automation can be optimized by injecting manual curation opportunities throughout the curation process. Some embodiments include both automatic and manual curation.

As new messages are identified for input into the platform, those messages can be defined to the Curator, either as a completely new category of message (a direct “is A” descendent of the IAO IBE concept) or as a variant of some previously defined message that descends from the IAO IBE concept. Definitions of organizationally-specific industry standard messages can descend from the industry standard message definition on which it is based, which itself is a direct descendent of the IAO IBE concept.

Structures and mappings defined for any supertype IBE messages are technically inherited by any new IBE message, although manual curation against the real-world message definition could violate this inheritance. Therefore, when IBEs are defined as subtypes of each other, quality assurance analysis can be conducted to look for inconsistencies across the resulting siblings, or gaps between message types and inferred supertype messages.

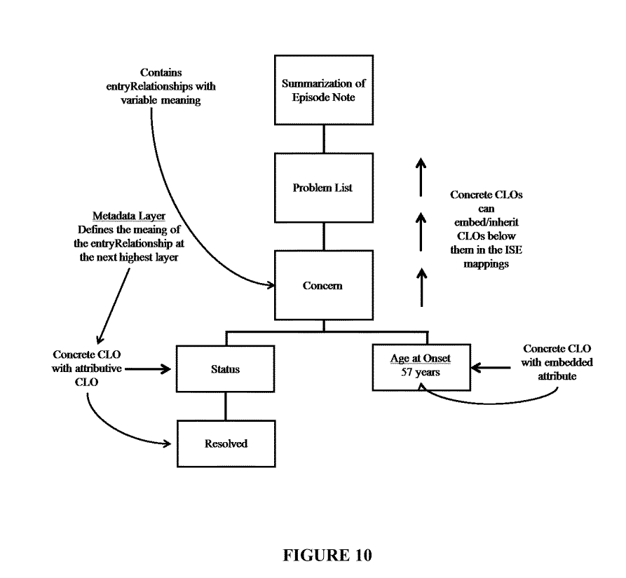

FIG. 10 illustrates some of the complexity in the deconstruction of an IBE such as the XML standard for a CDA document. The concern is an entity with variable meaning. If the associated metadata provides a concrete CLO and corresponding attributive CLOs having a value for the concern that exists within recognized tags, then the concern status is deemed resolved. The concern can alternatively be a concrete CLO with an embedded attribute, such as age of onset, for example, 57 years. The concrete CLO can embed/inherit CLOs in lower tiers of the mapping, and reduce the concern to a problem list, leading to a summarization of an episode note.

Some source fields have their values mapped through coded components and tags, while others are found to be values within existing recognized tags. All of this complexity can occur within nested coded structures that represent different functional components of arbitrarily complex messages.

The use of the Information Artifact Ontology in the Curator specifically targets the handling of these complexities and variables in a systematic and manageable way by decomposing messages into structural and content components that can be mapped against other ontologies, and into CLO schema that can be defined dynamic during message curation.

This curation categorization can function in two different but supportive roles: 1) by looking at a formal definition of the message type without content, such as the HL7 CDA standard, or 2) by looking at a corpus of messages to extract actual maps from real data, and the adjusting the mappings to manage differences or inconsistencies in the natural variations across messages in the corpus. The former approach has the advantage of not having message variation to deal with, while the latter approach has the advantage of having actual real data to map. Since a lot of mapping in healthcare messages is based on the actual content of the messages processes, the corpus-based approach is most likely to lead to final mappings that can be used to drive ETL processes. The more formal standard-based mappings might serve as important interim mappings that would support further corpus-based mapping. These alternatives remain to be explored to determine an optimal approach.

### Identify Information Carriers.

Any valued Path in the message structure can be curated as an Information Content Entity (ICE). Many of the tags in the message represent message overhead—dictated by the CDA standard—that does not need to be loaded into the platform, and yet some of those data are useful in aiding the curation process. The TemplateID identifies this observation block as a CDA Age Observation. The status code indicates that the observation is complete

ICEs are also subject to an additional layer of curation in the IAO, including subtypes that might prove useful both in support of curation itself, as well as aiding in automated ETL processing of these messages by the platform. Examples include curating the Value ICE as a Time Measurement Datum, and the Unit ICE as a Time Unit.

### Define Protections.

Some of the data protections provided by the platform are defined through the categorization of ICEs against the OBI ontology. Specifically, some of the ICEs are mapped to the Individual Organism Identifier or Patient Role concepts and so are accessible to the platform tokenization of those values.

Data requires protection as PHI data under HIPAA; not just because it is an address, but because it is an address in an ICE that includes patientRole directly above it in its Path definition (as opposed, say, to a hospital address included up in the header of the message). The ISE for the Address structural component can flagged as PHI by the curator.

### Token Manager.

Tokens are the internal identifiers of the platform that allow for deidentification of data arriving from various institutional source systems. The types of message components that are expected to be tokenized in the platform, include both continuant identifiers such as MRNs; temporal event identifiers that would be unique to such continuants, such as encounter or visit identifiers; as well as operational identifiers within those temporal events, such as order numbers.

The management of tokens entails defining the source identifiers that need to be converted into tokens within the platform, and the relationships and precedence priorities among those source identifiers. The platform has a set of defined identifiers that have been built into a hierarchy for processing. The root of the hierarchy can be the Enterprise Master Person Identifier (EMPI) of the platform that is assigned and maintained within the platform. Other nodes can be defined by curators working to map source data elements to the system.

For example, there can be identifiers defined for three different institutions: a hospital/healthcare institution, a federal healthcare institution, and a specified local institution. Different institutions can have their own branches of the identifier tree, although the same identifier might show up in the tree in multiple positions if shared across multiple institutions (e.g. Social Security Numbers).

Each institutional branch can start with the identifier used by the institution as a master identifier. A mature institution can have a single identifier that they treat as an EMPI, but the platform provides no restriction on the number of identifiers an institution might curate as an EMPI. Below an institution's EMPI identifier is a hierarchic cascade of additional non-EMPI identifiers, either unique or non-unique.

### Token Identifiers.

Generally, any data that can lead to identifying a Concrete CLO that is associated with the OBI Patient Role or Specimen Role can be tokenized in the platform. Additionally, data defined in the platform as an instance of the IAO Centrally Registered ID (CRID) concepts associated with an Organism or Specimen identifiers can be tokenized. These latter identifiers, being centrally registered, can also require that the organization doing the assignment of such identifiers be included in the tokenization algorithm to maintain uniqueness of tokenized identifiers in the platform.

### Resolve Collisions.

The automatic curation capabilities of the platform can result in numerous conflicts and collisions among mapped concepts. Some of this occurs because of inherent cross-ontology inconsistencies among the various ontologies loaded into the platform. Other issues can arise because of ambiguities and inconsistencies in the curated messages themselves. A human curator can resolve these problems explicitly.

### Maps ICEs to CLOs.

Beyond structural mappings, the ultimate purpose of the curation process is to finalize the mapping of inbound message values to specific Functional CLOs in the platform repository. Many messages include enough metadata to be able to auto-curate this final linkage, while other message values are mappable through human-based manual curation. The curation process can additionally automatically parse many message types to create initial or intermediate schema proposals, map input fields to conceptual and functional ontologies, and define concrete CLO schema properties.

### Ontology Loader.

The Ontology Loader of the platform is used to populate conceptual CLOs for all of the nodes and relationships available in any public or private ontology available for loading. This includes initial loads of new ontologies, as well as regular maintenance of existing pre-loaded ontologies.

### Ontology Extender.

Across any of the ontologies stored in the platform, complete curation requires the ability to extend loaded ontologies to include local nodes, relationships, or instances that are not otherwise identified as being within those ontologies. The two heaviest uses of these capabilities are where a local ontology has been inferred from message content in the Message Mapper, and where existing relationships among nodes needs to be augmented to make them behave as desired in the Scaffold Navigator.

### Ontology Mapper.

The scaffolding capability of the platform supports queries that users make against the data by allowing concepts from multiple ontologies or semantic levels to be navigated automatically while searching for data to satisfy requests. While many mappings between ontologies are loaded into the platform as part of the regular maintenance of loaded ontologies, the Curator also offers a mechanism for support staff to augment those relationships explicitly.

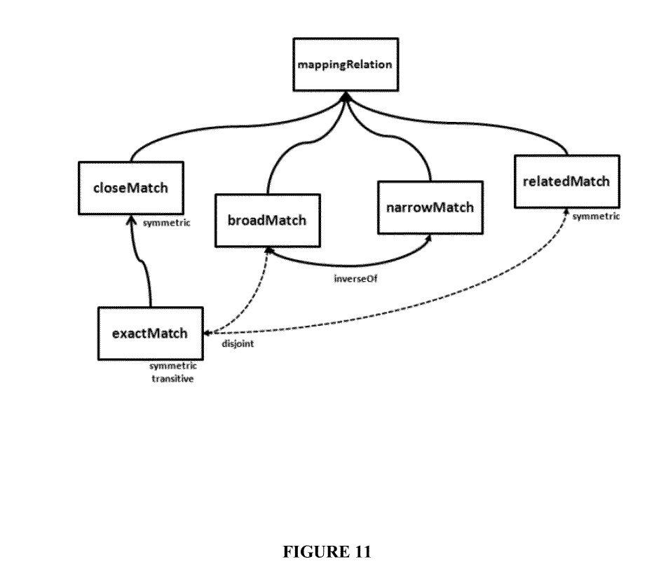

These inter-ontology mappings can serve a variety of purposes in the platform. FIG. 11 is a schematic representation of inter-ontology semantic conceptual mappings. This figure depicts the different levels of matching that can occur when a search is processed. Illustrative examples of matching levels include an exact match, a close match, a narrow match, and a related match, each of which, jointly or independently, can contribute to the final mapping relationship. Mappings among the semantic ontologies can support richer query navigation through the query scaffold functionality. Mappings to the support ontologies support the inclusion of exclusion of data from analysis based on query purposes.

Concepts mapped to the IAO ontology are generally message-dependent artifacts, and often convey no information of a clinical or research nature. Concepts mapped to OBI concepts typically convey information about the clinical setting from which data is being derived, but are not typically part of the clinical picture of a patient of interest to most clinically-oriented queries. Concepts mapped to the OGMS ontology are typically elements of a patient's clinical picture of interest in the queries of the platform.

All of this data might be of interest in any particular rule or query, and so all are available in the platform; but the mapping to support ontologies offers a pathway for optimizing what is included or excluded in many queries. Cross-mapping of semantic concepts to multiple support ontologies also offers an extensive opportunity for quality control and modeling of data in order to work toward continually improving mappings.

Mappings also offer an opportunity to conduct rudimentary quality assurance of the semantic data represented in the loaded ontologies. One common problem that the curation tool needs to identify and indicate involves bi-directional inconsistencies in semantic mappings among concepts.

### Instance Manager.

Instances of data that have been loaded into the platform, particularly instances that have been tokenized, can be managed over time to ensure continuous proper mapping and definition. On a regular basis, most healthcare institutions need to be able to merge patient definitions that have been created redundantly, or move encounters that have been defined against the wrong patient. The Instance Manager provides both automated and manually curated support for these capabilities.

### Orphan Management.

Most orphan adoptions are automatic, occurring when the containing ontology is next updated from its external source. Those orphans that do not automatically adopt in this way can remain in the orphan state unless manually curated. Such manual curation is optional, but assists in linking the concept to the broader set of mappings and curated data available across the conceptual network in the platform.

### Schema Builder.

The Schema Builder of the platform is used to infer the needed content of data structures to be derived from source messages that have been mapped to CLOs.

### Scaffold Navigator.

The Scaffold Navigator of the platform is used to allow queries written against one semantic ontology to be extended through to other ontologies to which concepts have been appropriately mapped within the ontologies themselves or by using curation tools provided in this platform. The Navigator determines what edges can be included, or must be excluded, from scaffold pathways through the ontologies with navigation typically being downward through the concepts toward narrower inclusive concepts.

Given a CLO as focal point, the Scaffold Navigator can follow edges away from the CLO; to establish its scaffold neighborhood, the neighborhood consisting of all CLOs one edge away. Edges that broaden the focal point CLO can be excluded from navigation, leaving only outbound edges that are curated as exact, close, or narrowing relations.

Each step in the process of scaffolding encompasses a processing step that can be included or excluded from the scaffold algorithm based on input from the query tool using the scaffold. This scaffold is typically thought of as on or off for any given query, but components of this algorithm can actually be included up to any point; providing increased flexibility and functionality to users of any supported query tool.

The starting point for scaffold logic is an expansion of any queried concept to include concepts that have been curated as being an exact match to the originating concept. Exact match relationships between concepts are directly sourced as part of any ontology load operation, or as an explicit result of curation in this tool suite. Because exact match relationships are transitive, some concepts are returned redundantly, requiring a mechanism for stopping any recursion generated by the concept search. The minimum implementation required for scaffolding is a simple neighborhood query, resulting in seeing only those concepts recorded as exact matches, without attempting to follow transitive exact match relationships further.

### Data Requirements.

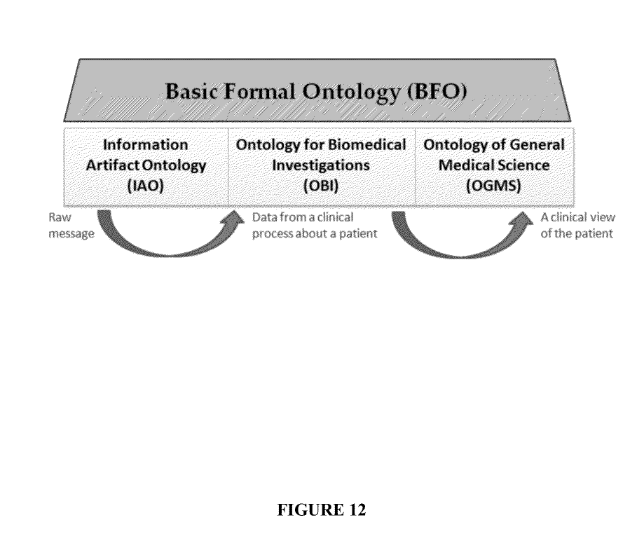

The platform Curator uses three high-level semantic ontologies, each of which has been mapped to the foundational Basic Formal Ontology (BFO). FIG. 12 depicts three of the ontologies used by the platform and how data flows from one ontology to the next. The Information Artifact Ontology (IAO) includes the concepts and relations necessary to functionally decompose message definitions for subsequent mapping into other semantic frames with the platform. The Ontology for Biomedical Investigation (OBI) includes the concepts and relations necessary to properly define and capture data related to the biomedical setting and activities that occur there. Data mapped through this ontology describes participants, roles, and actions of the clinical setting. The Ontology of General Medical Science (OGMS) includes the concepts and relations necessary to capture a clinical picture of a patient or subject. Data mapped through this ontology actually describes the clinical state of a patient or subject in some way.

These three ontologies can be extended by the platform to support other ontologies and general or functional requirements described elsewhere in this disclosure.

### Token Repository.

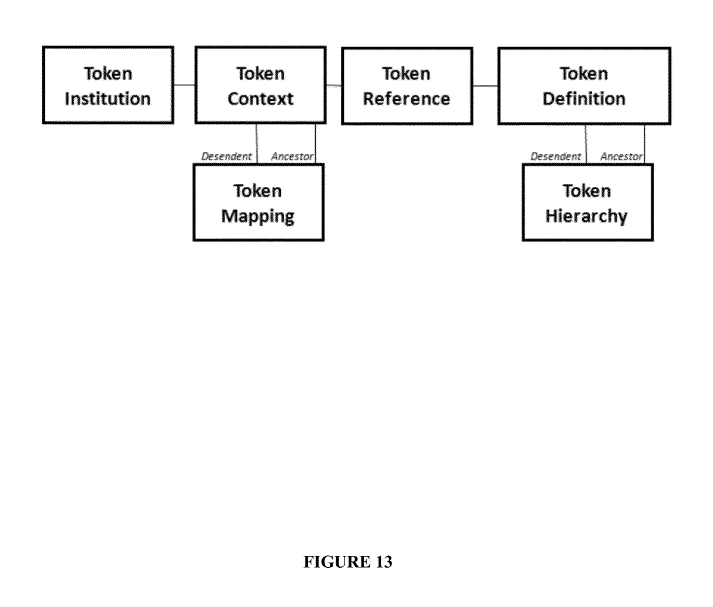

The Token Repository of the platform provides protected source message identifiers to be tokenized and consolidated into standard platform EMPI definitions. The repository maintains granular tokens for every distinct source natural key even after many such keys have been mapped to the same instance of patients. This granularity allows tokens to remain stable even as their mappings to different patients might change over time. The components of the token repository are illustrated in FIG. 13 and described herein as non-limiting examples of services and commands available in this capacity. They include: Token Institution: The organization or body that owns or controls the identifier being tokenized. Its main purpose is to ensure that all tokenized contexts are uniquely defined, without similar looking reference values from multiple institutions overlapping or colliding. Token Context: The definition of individual identifiers used by the enterprise to denote data. At least one of the contexts for an institution serves as a master index (EMPI) that can be unique. Other contexts for the same institution can be unique or non-unique, and can aggregate up to one of the institution's EMPI. Token Mapping: The relationships among the institution contexts. Token Reference: The instances of institutional contexts. Token Definition: The actual token and control values assigned to the set of references pointing to it. Token Hierarchy: The relationships among the reference instances.

Each reference is assigned its own platform token during processing. The layout of this hierarchy determines how data are processed during loading. Data received in against multiple simultaneous contexts (e.g. hospital and MRN) are tokenized against the lowest level token available (e.g., hospital and MRN).

Non-unique contexts require extra processing not needed for unique contexts. If a data feed is received that contains a non-unique context, it can be validated using both the received value and one of the unique identifiers. This extra validation can assure that data for a non-unique identifier is not inadvertently associated with the wrong EMPI.

### Clinical Support Tools and Applications for the Analysis of DNA/RNA Genomic Data.

A platform of the invention can analyze CLOs that include genomic information. Genomic information can be obtained from a subject, for example, in the following ways. 1) In pyrosequencing, DNA is amplified within a water droplet containing a single DNA template bound to a primer-coated bead in an oil solution. Nucleotides are added to a growing sequence, and the addition of each base is evidenced by visual light. 2) Ion semiconductor sequencing detects the addition of a nucleic acid residue as an electrical signal associated with a hydrogen ion liberated during synthesis. A reaction well containing a template is flooded with the four types of nucleotide building blocks, one at a time. The timing of the electrical signal identifies which building block was added, and identifies the corresponding residue in the template. 3) DNA nanoball uses rolling circle replication to amplify DNA into nanoballs. Unchained sequencing by ligation of the nanoballs reveals the DNA sequence. 4) In a reversible dyes approach, nucleic acid molecules are annealed to primers on a slide and amplified. Four types of fluorescent dye residues, each complementary to a native nucleobase, are added, the residue complementary to the next base in the nucleic acid sequence is added, and unincorporated dyes are rinsed from the slide. Four types of reversible terminator bases (RT-bases) are added, and non-incorporated nucleotides are washed away. Fluorescence indicates the addition of a dye residue, thus identifying the complementary base in the template sequence. The dye residue is chemically removed, and the cycle repeats. Once obtained, genomic data can be searched and analyzed along with any other data and CLOs accessible to the platform. The genomic data can be used for personalized clinical care, research, and population analysis/discovery purposes.

Any tool, interface, engine, application, program, service, command, or other executable item can be provided as a module encoded on a computer-readable medium in computer executable code. In some embodiments, the invention provides a computer-readable medium encoded therein computer-executable code that encodes a method for performing any action described herein, wherein the method comprises providing a system comprising any number of modules described herein, each module performing any function described herein to provide a result, such as an output, to a user.

### EXAMPLES

### Example 1

### Data Flow Schematic

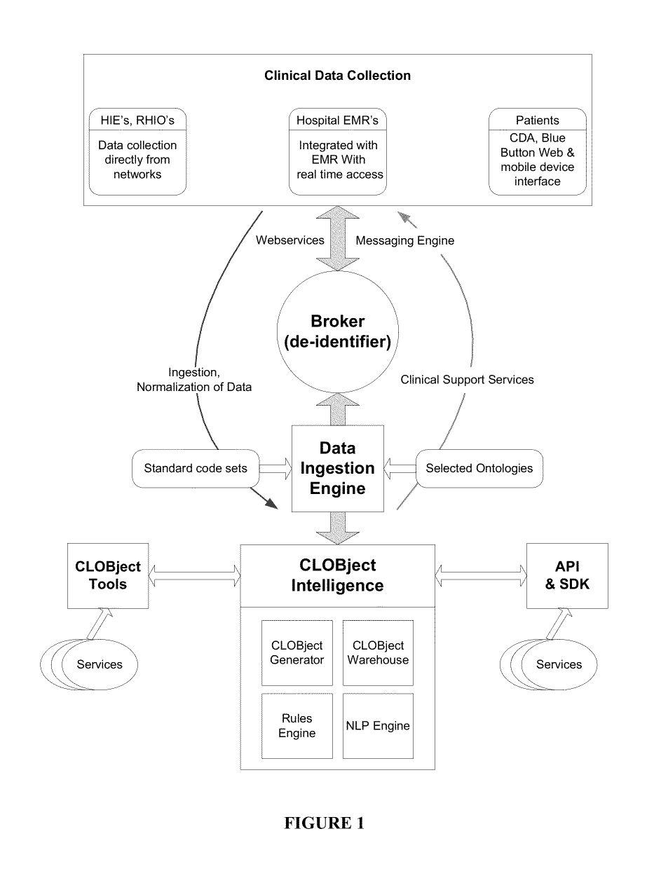

FIG. 1 shows that metadata collection occurs at various levels, directly from healthcare networks, hospitals, or patients themselves. Using a web-based broker, the data is de-identified to comply with patient privacy and HIPAA standards. The data is then ingested, which comprises of streamlining data to facilitate mapping of data to normalized data definitions in later processing at the Object Intelligence stage. Additionally, existing ontologies within the software are applied to the newly inputted data to create Objects at the Object Intelligence stage.

As depicted in FIG. 1, The Object Intelligence stage consists of the Object Generator, Object Warehouse, Rules manager, and the Natural Language Processing (NLP) engine. These components allow for the generation, storage, analysis, maintenance, and distribution of the Objects. At this point, the software provides a modern Application Programming Interface (API) for developers and researchers to view content. The Object Intelligence stage creates a set of Object Tools that can be used for further analysis of Objects of interest. The Object Intelligence can be improved by updating the platform via an application programming interface (API) or a software development kit (SDK).

FIG. 1 illustrates that the overall data flow dynamic of the software platform is bi-directional in that data not only flows into the Object Intelligence stage, but also out of the stage as a method to provide clinical support services. Clinical Decision Support systems (CDS) can be employed where recommendations regarding patient care are made to the user via a messaging engine. These messages can be displayed to any of the original users—healthcare networks, hospitals, and/or patients.

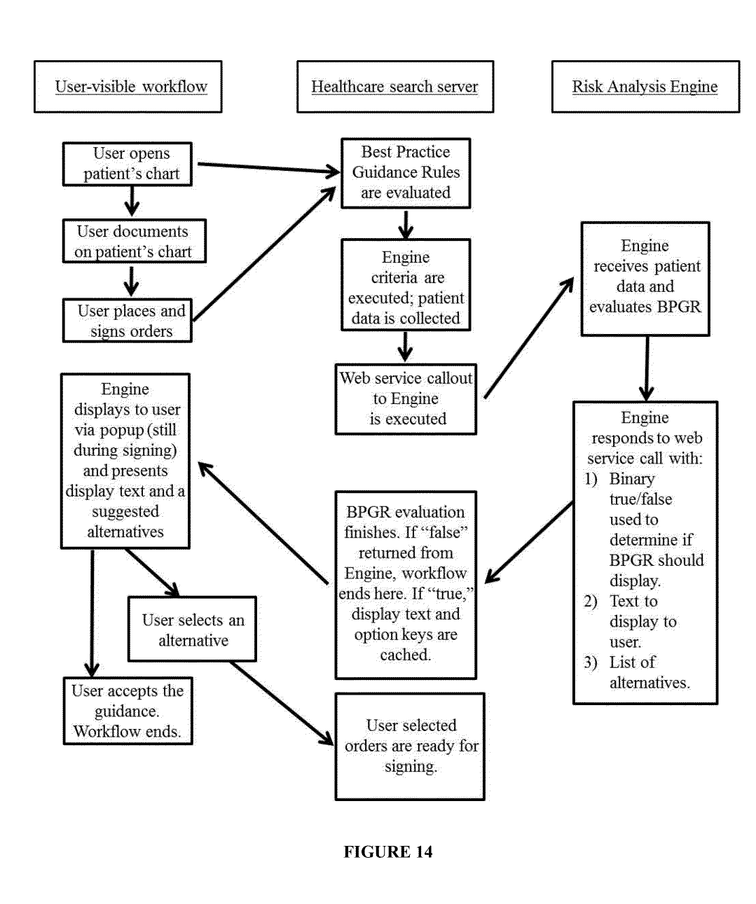

FIG. 14 illustrates an example of how a workflow can proceed upon analysis of a patient chart. Opening of the patient chart is a trigger action, which causes Best Practice Guidance Rules (BPGRs) to be evaluated. This evaluation occurs via a specified healthcare search server. The second trigger point for BPGR evaluation is when the user places and signs an order for the patient. When one or both of these trigger points is executed, data is collected, and a call to the Risk Analysis Engine is initiated. The Risk Analysis Engine evaluates this input along with other patient data and determines if the user needs to be shown an alert. If “false” is returned from the Engine, the workflow ends. If “true” is returned, then an alert is displayed to the user, which not only contains the patient-specific concern, but also a set of options for issuing orders that can be appropriate for the patient. At this point the user can either accept the guidance and end the workflow or accept a suggested order set. If the latter option is chosen, the order set is loaded from the healthcare search server and displayed to the user.

### Example 2

### Computer Architectures

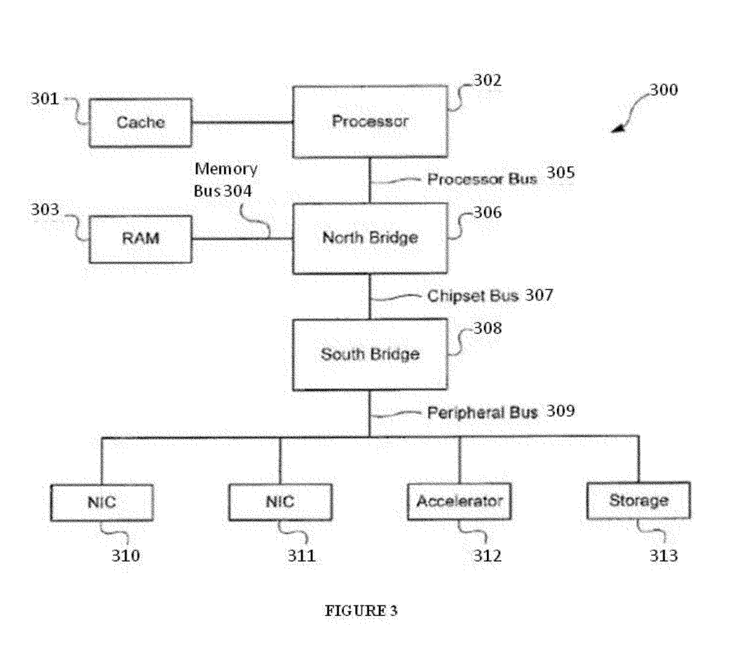

Various computer architectures are suitable for use with the invention. FIG. 3 is a block diagram illustrating a first example architecture of a computer system 300 that can be used in connection with example embodiments of the present invention. As depicted in FIG. 3, the example computer system can include a processor 302 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 3, a high speed cache 301 can be connected to, or incorporated in, the processor 302 to provide a high speed memory for instructions or data that have been recently, or are frequently, used by processor 302. The processor 302 is connected to a north bridge 306 by a processor bus 305. The north bridge 306 is connected to random access memory (RAM) 303 by a memory bus 304 and manages access to the RAM 303 by the processor 302. The north bridge 306 is also connected to a south bridge 308 by a chipset bus 307. The south bridge 308 is, in turn, connected to a peripheral bus 309. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 309. In some architectures, the functionality of the north bridge can be incorporated into the processor instead of using a separate north bridge chip.

In some embodiments, system 300 can include an accelerator card 312 attached to the peripheral bus 309. The accelerator can include field programmable gate arrays (FPGAs) or other hardware for accelerating certain processing.

### Software Interface(s).

Software and data are stored in external storage 313 and can be loaded into RAM 303 and/or cache 301 for use by the processor. The system 300 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 300 also includes network interface cards (NICs) 310 and 311 connected to the peripheral bus for providing network interfaces to external storage, such as Network Attached Storage (NAS) and other computer systems that can be used for distributed parallel processing.

### Computer Systems.

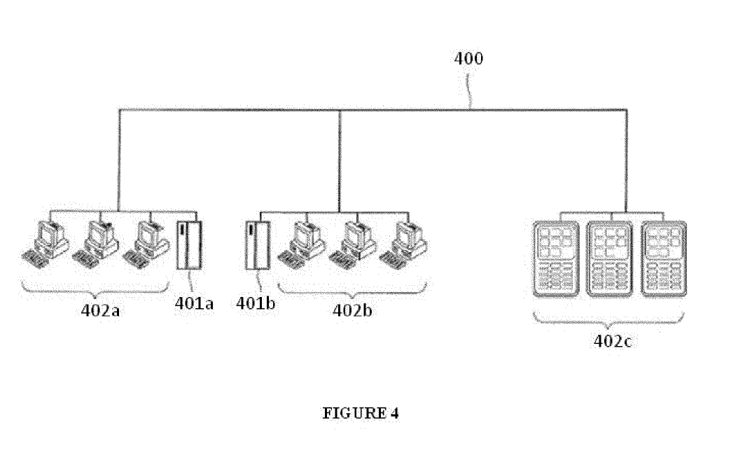

FIG. 4 is a diagram showing a network 400 with a plurality of computer systems 402a, and 402b, a plurality of cell phones and personal data assistants 402c, and Network Attached Storage (NAS) 401a, and 401b. In some embodiments, systems 402a, 402b, and 402c can manage data storage and optimize data access for data stored in Network Attached Storage (NAS) 401a and 402b. A mathematical model can be used for the data and be evaluated using distributed parallel processing across computer systems 402a, and 402b, and cell phone and personal data assistant systems 402c. Computer systems 402a, and 402b, and cell phone and personal data assistant systems 402c can also provide parallel processing for adaptive data restructuring of the data stored in Network Attached Storage (NAS) 401a and 401b. FIG. 4 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

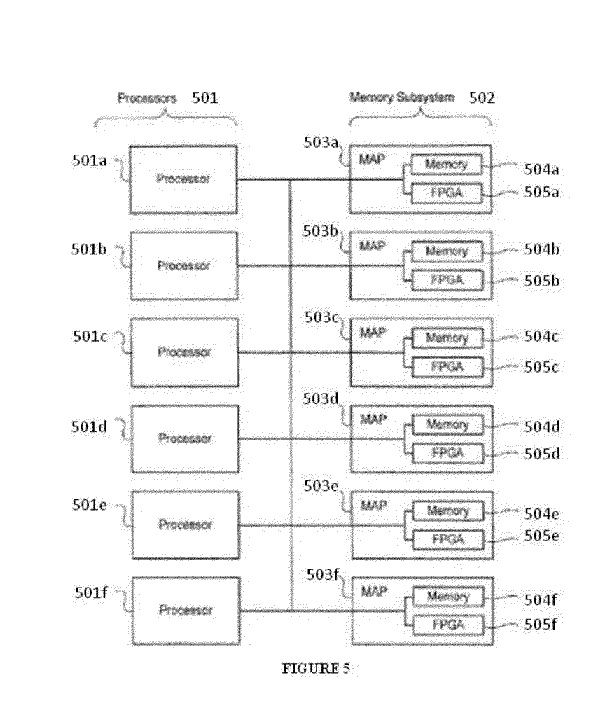

FIG. 5 is a block diagram of a multiprocessor computer system using a shared virtual address memory space. The system includes a plurality of processors 501a-f that can access a shared memory subsystem 502. The system incorporates a plurality of programmable hardware memory algorithm processors (MAPs) 503a-f in the memory subsystem 502. Each MAP 503a-f can comprise a memory 504a-f and one or more field programmable gate arrays (FPGAs) 505a-f. The MAP provides a configurable functional unit and particular algorithms or portions of algorithms can be provided to the FPGAs 505a-f for processing in close coordination with a respective processor. In this example, each MAP is globally accessible by all of the processors for these purposes. In one configuration, each MAP can use Direct Memory Access (DMA) to access an associated memory 504a-f, allowing it to execute tasks independently of, and asynchronously from, the respective microprocessor 501a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 5, system on chips (SOCs), application specific integrated circuits (ASICs), or other processing and logic elements. For example, the Set Processor and Optimizer can be implemented with hardware acceleration through the use of a hardware accelerator card, such as accelerator card 312 illustrated in FIG. 3.

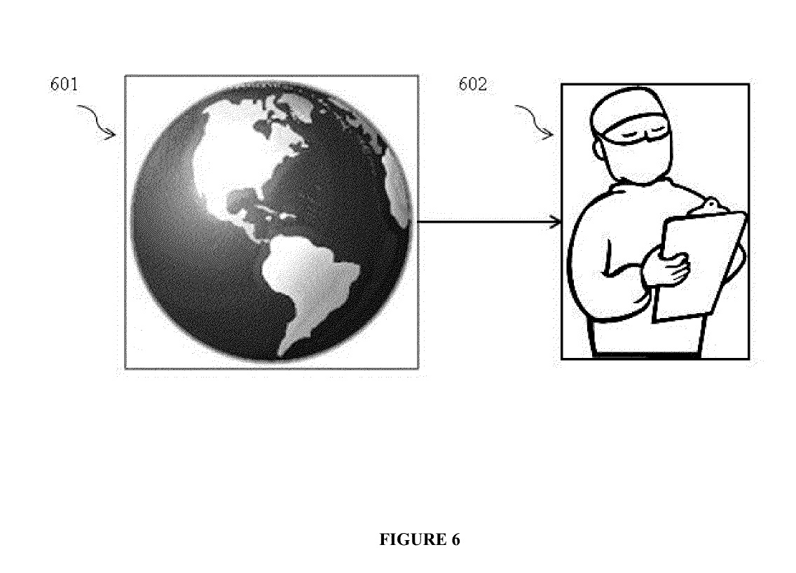

Any embodiment of the invention described herein can be, for example, produced and transmitted by a user within the same geographical location. A product of the invention can be, for example, produced and/or transmitted from a geographic location in one country and a user of the invention can be present in a different country. In some embodiments, the data accessed by a system of the invention is a computer program product that can be transmitted from one of a plurality of geographic locations 601 to a user 602 (FIG. 6). Data generated by a computer program product of the invention can be transmitted back and forth among a plurality of geographic locations, for example, by a network, a secure network, an insecure network, an internet, or an intranet. In some embodiments, an ontological hierarchy provided by the invention is encoded on a physical and tangible product.

### Example 3

### Mapping of Morbid Obesity Using Human Disease (DOID) Ontology

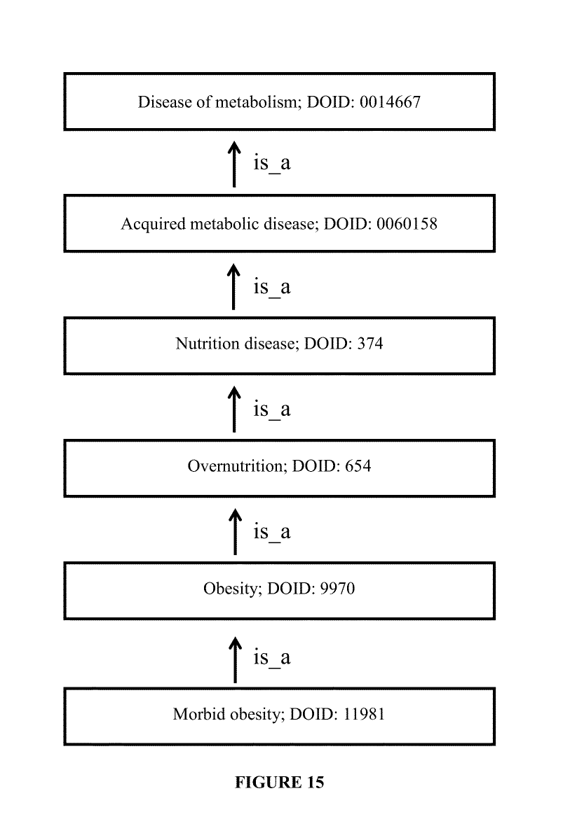

A user opts to use the DOID ontology to search for morbid obesity. The user searches and is provided with a list of synonyms as displayed in TABLE 4. Terms are retrieved by comparing the searched term to an ontology mapping module of the platform, which identifies synonyms in multiple ontological hierarchies. In this case, the synonyms are morbid obesity, morbid obesity (disorder), and severe obesity. Additionally, the search displays other ontological databases used for cross-referencing of the term, as shown in TABLE 4. Finally, the DOID displays the hierarchy of the term which shows not only the specified term, but also the parents, as illustrated in FIG. 15. In this instance, the least specialized term is “disease of metabolism”, which ultimately leads the ontological tree to “morbid obesity”, the most specialized term. The hierarchy reveals that morbid obesity is a type of obesity, which falls under the category of overnutrition. Overnutrition is a nutrition disease, which falls under acquired metabolic diseases, leading to the parent of the ontological tree, “disease of metabolism”.

TABLE 4
DOID: 11981, Morbid Obesity

| | |
|---|---|
| preferred name | Morbid obesity |
| exact synonym | Morbid obesity (disorder) |
| | [SNOMEDCT_2005_07_31:238136002] |
| exact synonym | Morbid obesity |
| | [SNOMEDCT_2005_07_31:389986000] |
| exact synonym | Morbid obesity [ICD9CM_2006:278.01] |
| exact synonym | Severe obesity [MTHICD9_2006:278.01] |
| exact synonym | Morbid obesity |
| | [SNOMEDCT_2005_07_31:190967003] |
| exact synonym | Morbid Obesity [NCI2004_11_17:C34858] |
| exact synonym | SNOMEDCT_2010_1_31:238136002 |
| xref_analog | SNOMEDCT_2010_1_31:190967003 |
| xref_analog | SNOMEDCT_2010_1_31:389986000 |
| xref_analog | UMLS_CUI:C0028756 |
| xref_analog | NCI:C34858 |
| xref_analog | MSH:D009767 |
| xref_analog | ICD9CM:278.01 |

### Example 4

### Mapping of Hearing Loss Using Human Phenotype (HP) Ontology (Parents)

A user executes a search in the HP ontology for hearing loss. TABLE 5 shows the results obtained by consulting an ontology mapping module of the platform. The user is presented with exact synonyms determined by the ontology; in this case, hearing defect is a synonym for hearing loss in the HP ontology. The search finds equivalent terms in the UMLS ontology.

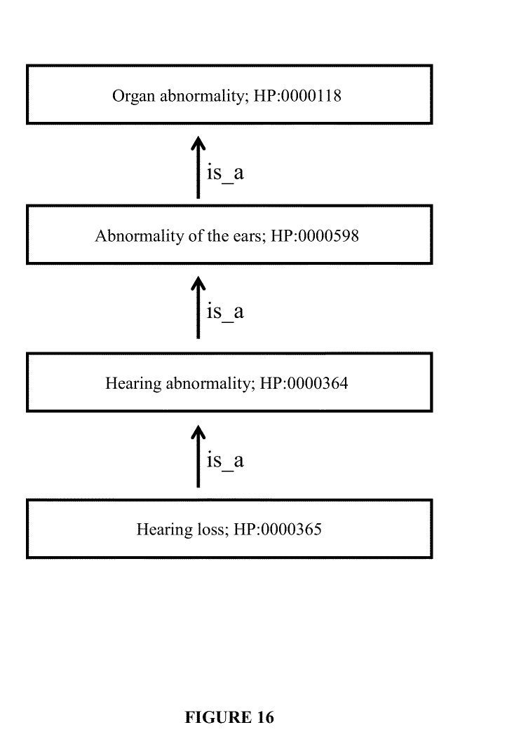

FIG. 16 illustrates the hierarchy created when the user searches for hearing loss. FIG. 16 shows that organ abnormality is the highest parent of hearing loss, and that hearing loss is a type of hearing abnormality, which is an abnormality of the ears, which is an organ abnormality.

TABLE 5
HP:0000365, Hearing loss

| | |
|---|---|
| preferred name | Hearing loss |
| exact synonym | Hearing defect |
| xref_analog | UMLS:C1861101 |
| xref_analog | UMLS:C0018767 |
| xref_analog | UMLS:C0600055 |
| xref_analog | UMLS:C1457869 |
| xref_analog | UMLS:C1384666 |

### Example 5

### Mapping of Hearing Loss Using the HP Ontology (Children)

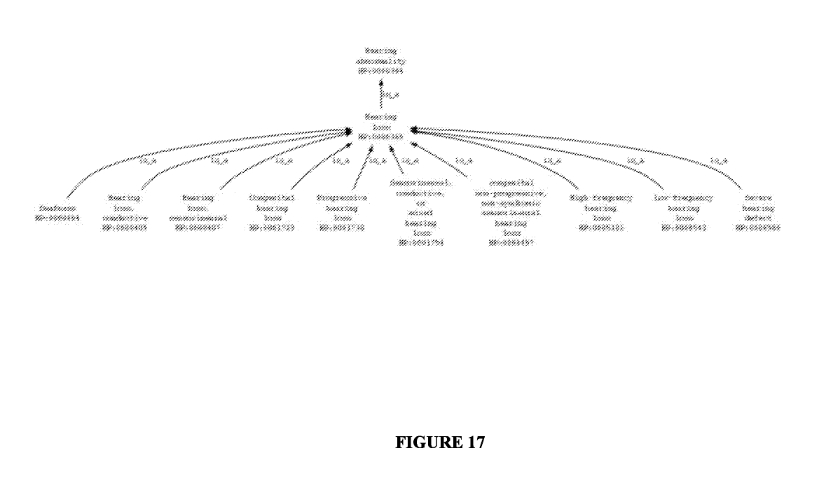

After searching for hearing loss in the HP ontology, the user wishes to know what diseases fall under the domain of hearing loss. FIG. 17 illustrates a downward expansion of the hierarchy. The user is able to see all the children terms of hearing loss contained within the HP ontology and the direct parent term of hearing loss, “hearing abnormality”. The children of hearing loss contained within the HP ontology are deafness, hearing loss (conductive), hearing loss (sensorineural), congenital hearing loss, progressive hearing loss, sensorineural, conductive, or mixed hearing loss, congenital, non-progressive, non-syndromic sensorineural hearing loss, high-frequency hearing loss, low-frequency hearing loss, and severe hearing defect.

### Example 6

### Workflow Diagram of a Physician Case

A clinician user, Dr. G, has as a patient a 72-year-old woman with diabetes, hypertension, hyperlipidemia, lupus, and a history of CVA. The first triggering event of the workflow is his opening of the encounter with the patient. This triggers two rules, which are communicated to the platform of the invention. An empty response is outputted and thus no messages are displayed to Dr. G. Dr. G then enters orders for the patient, and in doing so, triggers a rule, which yields no alerts. Dr. G then obtains a patient history and examines the patient. Following examination, Dr. G signs an order for Plavix™. This order is a triggering event. The check-for-alert code triggers a platform rule, which is presented as an alert to Dr. G. Dr. G then changes the Plavix™ dosage as suggested by the alert. This change is again a triggering event, yielding no alerts as the dose entered was acceptable. Dr. G closes the encounter. Closing of an encounter is the final triggering event, which yields no alerts. The workflow ends.

### Example 7

### Guiding a Clinical Outcome with a System of the Invention

A 44 year old caucasian male (subject A) is being cared for at Hospital A. Clinician B is treating Subject A. Subject A tells clinician B that subject A is suffering from extreme facial pain. The clinician diagnoses subject A with a disease, Trigeminal Neuralgia. Trigeminal Neuralgia is a condition associated with high levels of pain. The clinician considers prescribing a standard-of-care treatment, 100 mg of Tegretol.

Through the clinician adding a diagnosis of Trigeminal Neuralgia to the patient's Electronic Medical Record (EMR), a diagnosis of trigeminal neuralgia is added to subject A's CLO Cluster. The addition of this new diagnosis triggers a rule that calls for re-assessment of subject A's CLO Cluster. The system evaluates subject A's phenotype, genotype, demographic, prescription drug records, and other CLOs in subject A's electronic health records. The system determines that subject A carries a genotype associated with high risk for serious and sometimes fatal dermatological reactions with carbamazepine (Tegretol™). The system outputs a message to clinician B informing the clinician of the risks associated with prescribing carbamazepine to subject A. The system further outputs a message reciting: “Consider prescribing an alternative medication. All medications below are approved for use in trigeminal neuralgia and are not known to be affected by this subject's pharmacogenomic profile: a) Gabapentin (Neurotin™); b) Pregabalin (Lyrica™); and c) Amitriptyline (Elavil™)”. The message provides the prescribing label for each therapy as a clickable link for clinician A to review as desired. The clinician selects and prescribes the recommended therapeutically-effective dosage of Pregabalin to subject A.

After taking Pregabalin for a specified period of time, subject A returns to Hospital A for a follow up visit with clinician B. Subject A's symptoms have improved and subject A is tolerating the prescribed medication well. Clinician B adds subject A's symptom resolution and medication tolerance to the patient's Electronic Medical Record (EMR) and therefore these data are automatically reflected in the patient's CLO's within the platform. The platform learns the outcome of subject A's treatment and can use this information to inform future clinical decisions.

### Example 8

### Illustration of Search Terms in a Graphic User Interface

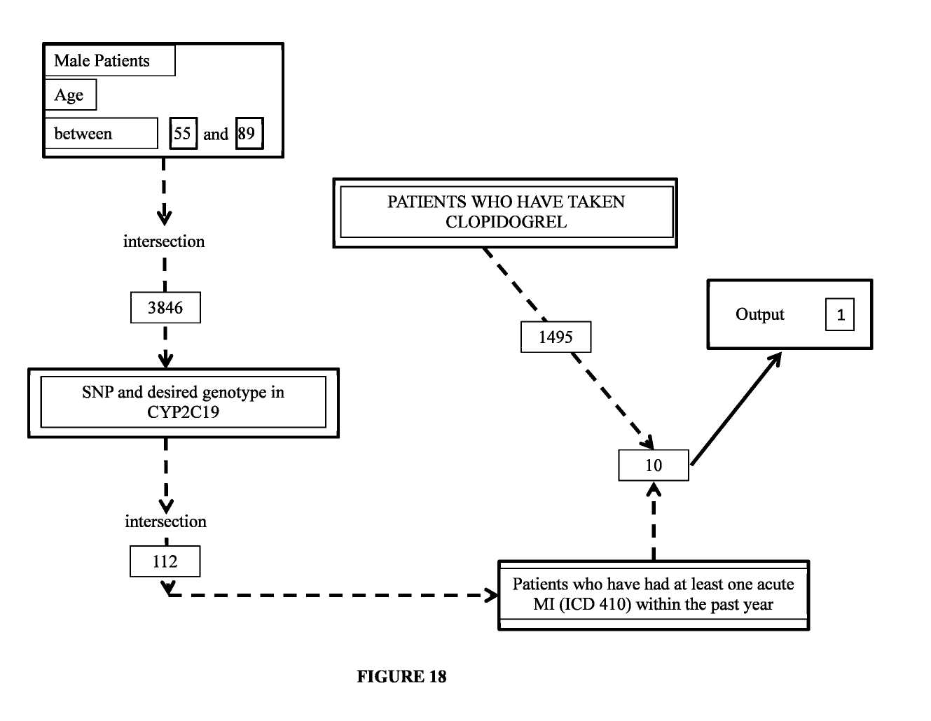

FIG. 18 depicts an illustrative search interface for the platform. In this instance, the user wishes to identify male patients with a specific SNP in CYP2C19 who have had a myocardial infarction (MI) within one year of starting a course of Clopidogrel treatment. First, the user searches for male patients who are between the ages of 55 and 89. The intersection operator returns only the results of those male patients who are between 55 and 89 years of age, showing that there are 3846 such patients. The user further specifies the SNP and desired genotype in CYP2C19; the intersection operator returns 112 results. Next, the user narrows the search further by requesting patients who have had at least one acute MI (ICD 410) within the past year; this returns 10 result. Further, the user adds a search condition for patients who have taken Clopidogrel, returning 1495 results. The final output, which satisfies all of the criteria of the specified search query, yields one patient. The search terms are illustrated graphically rather written as a textual string, improving efficiency and availing the platform to novice users with minimal clinical or IT training.

### EMBODIMENTS

The following non-limiting embodiments provide illustrative examples of the invention, but do not limit the scope of the invention.

### Embodiment 1

In some embodiments, the invention provides a method comprising: a) receiving a search term; b) identifying, based on the search term, a result clinical concept that is recognized by a first standardized ontological hierarchy; c) identifying in a second standardized ontological hierarchy a corresponding clinical concept, wherein the corresponding clinical concept has a clinical meaning that is substantively-similar to the clinical meaning of the result clinical concept; d) searching by a computer processor a database of electronic health records based on the corresponding clinical concept; e) identifying an electronic health record in the database associated with the corresponding clinical concept; and f) outputting a result.

### Embodiment 2

The method of embodiment 1, further comprising identifying corresponding clinical concepts in at least 10 other standardized ontological hierarchies.

### Embodiment 3

The method of any one of embodiments 1-2, further comprising identifying a cohort of subjects that includes the corresponding clinical concept in the electronic health record of each subject of the cohort.

### Embodiment 4

The method of embodiment 3, wherein the cohort includes a subject identified based on the first standardized ontological hierarchy and a subject identified based on the second standardized ontological hierarchy.

### Embodiment 5

The method of any one of embodiments 1-4, wherein the output result provides clinical decision support based on the search.

### Embodiment 6

The method of any one of embodiments 1-5, further comprising receiving instructions to create a rule based on the output result.

### Embodiment 7

The method of embodiment 6, wherein the rule is activated when a user enters the search term or a clinical concept with a substantially-similar clinical meaning as the search term.

### Embodiment 8

The method of embodiment 6, wherein the rule is activated when an electronic health record is updated.

### Embodiment 9

The method of embodiment 6, wherein the rule alerts a user to a risk.

### Embodiment 10

The method of embodiment 6, wherein the rule associates the search term with genomic information.

### Embodiment 11

In some embodiments the invention provides a method comprising: a) selecting a search module on a graphical display of a computer system; b) positioning a first dialogue box associated with the selected search module by moving the first dialogue box onto a portion of the graphical display; c) inputting into the first dialogue box a first search term; d) positioning a second dialogue box on the graphical display; e) inputting into the second dialogue box a second search term; f) illustrating on the graphical display a logic operator connecting the first dialogue box and the second dialogue box; g) searching a database of electronic health records based on the first search term, the second search term, and the logic operator, wherein a processor associated with the computer system determines a search strategy by analyzing a graphical relationship among the first search term, the second search term, and the logic operator; and h) receiving an output of search results.

### Embodiment 12

The method of embodiment 11, further comprising identifying an additional term that has a substantially-similar clinical meaning as the first search term.

### Embodiment 13

The method of any one of embodiments 11-12, further comprising creating a rule based on the first search term.

### Embodiment 14

The method of embodiment 13, wherein the rule is triggered when one of the electronic health records is updated.

### Embodiment 15

The method of embodiment 13, wherein the rule is triggered when one of the electronic health records is updated with a risk factor associated with the first search term.

### Embodiment 16

The method of any one of embodiments 13-15, wherein the rule is triggered when a new electronic health records is created.

### Embodiment 17

The method of any one of embodiments 13-16, wherein the rule encodes an alert to be transmitted when the rule is triggered.

### Embodiment 18

The method of any one of embodiments 13-17, wherein the rule describes a relationship between genomic data and an associated risk factor.

### Embodiment 19

The method of any one of embodiments 13-17, wherein the rule describes a relationship between phenotypic data and an associated risk factor.

### Embodiment 20

The method of any one of embodiments 11-19, wherein the moving the first dialogue box onto a portion of the graphical display comprises dragging and dropping the first dialogue box.

### Embodiment 21

The method of any one of embodiments 11-20, wherein the graphical display comprises a snap-to grid.

### Embodiment 22

The method of any one of embodiments 11-21, wherein one of the electronic health records is an electronic medical record.

### Embodiment 23

The method of any one of embodiments 11-22, wherein one of the electronic health records is an electronic pharmacy record.

### Embodiment 24

The method of any one of embodiments 11-23, further comprising recommending an intervention for a subject based on the output.

### Embodiment 25

In some embodiments, the invention provides a method comprising: a) providing on a computer system a graphical display; b) receiving instructions to populate the graphical display with movable dialogue boxes; c) receiving a search term for each movable dialogue box independently; d) receiving instructions to connect the movable dialogue boxes graphically with a logic operator; e) receiving instructions to search a database of electronic health records based on the search terms and the logic operator; f) analyzing by a processor associated with the computer system a graphical relationship among the search terms and the logic operator; g) determining a search strategy based on the analysis; h) searching the database of electronic health records; and i) outputting a result of the search.

### Embodiment 26

The method of embodiment 25, further comprising identifying an additional term that has a substantially-similar clinical meaning as the first search term.

### Embodiment 27

The method of any one of embodiments 25-26, further comprising receiving input of a rule, wherein the rule is based on the first search term.

### Embodiment 28

The method of embodiment 27, wherein the rule is triggered when one of the electronic health records is updated.

### Embodiment 29

The method of embodiment 27, wherein the rule is triggered when one of the electronic health records is updated with a risk factor associated with the first search term.

### Embodiment 30

The method of any one of embodiments 27-29, wherein the rule is triggered when a new electronic health records is created.

### Embodiment 31

The method of any one of embodiments 27-30, wherein the rule encodes an alert to be transmitted when the rule is triggered.

### Embodiment 32

The method of any one of embodiments 27-31, wherein the rule describes a relationship between genomic data and an associated risk factor.

### Embodiment 33

The method of any one of embodiments 27-32, wherein the rule describes a relationship between phenotypic data and an associated risk factor.

### Embodiment 34

The method of any one of embodiments 27-33, wherein the graphical display comprises a snap-to grid.

### Embodiment 35

The method of any one of embodiments 27-34, wherein one of the electronic health records is an electronic medical record.

### Embodiment 36

The method of any one of embodiments 27-35, wherein one of the electronic health records is an electronic pharmacy record.

### Embodiment 37

The method of any one of embodiments 27-36, further comprising recommending an intervention for a subject based on the output.

### Embodiment 38

In some embodiments, the invention provides a method comprising: a) receiving an update of an electronic health record of a subject with additional clinical information, wherein the electronic health record comprises a genomic data of the subject; b) evaluating by a computer processor a relationship between the additional clinical information and the genomic data of the subject; c) identifying a correlation between the additional clinical information and the genomic data of the subject; and d) reporting the correlation between the additional clinical information and the genomic data of the subject.

### Embodiment 39

The method of embodiment 38, wherein the correlation between the additional clinical information and the genomic data of the subject identifies a susceptibility of the subject to a risk.

### Embodiment 40

The method of any one of embodiments 38-39, wherein the correlation between the additional clinical information and the genomic data of the subject identifies a susceptibility of the subject to an intervention.

### Embodiment 41

The method of any one of embodiments 38-40, wherein the correlation between the additional clinical information and the genomic data of the subject identifies a resistance of the subject to a risk.

### Embodiment 42

The method of any one of embodiments 38-41, wherein the correlation between the additional clinical information and the genomic data of the subject identifies a resistance of the subject to an intervention.

### Embodiment 43

The method of any one of embodiments 38-42, further comprising recommending an intervention for the subject based on the report of the correlation between the additional clinical information and the genomic data of the subject.

### Embodiment 44

The method of any one of embodiments 38-43, further comprising alerting a user that the electronic health record of the subject was updated with additional clinical information.

### Embodiment 45

The method of embodiment 44, wherein the alert provides clinical decision support.

### Embodiment 46

The method of any one of embodiments 38-45, further comprising preventing the update of the additional clinical information into the electronic health record of the subject.

### Embodiment 47

In some embodiments, the invention provides a method comprising: a) inputting to a computer system an update to an electronic health record of a subject, wherein the electronic health record comprises a genomic data of the subject, wherein the update provides additional clinical information; b) receiving a report of a correlation between the additional clinical information and the genomic data of the subject, wherein the correlation is determined by an evaluation of a relationship between the additional clinical information and the genomic data of the subject, wherein the evaluation is performed by a processor of the computer system; and c) receiving a report of the correlation between the additional clinical information and the genomic data of the subject.

### Embodiment 48

The embodiment of claim 47, wherein the correlation between the additional clinical information and the genomic data of the subject identifies a susceptibility of the subject to a risk.

### Embodiment 49

The method of any one of embodiments 47-48, wherein the correlation between the additional clinical information and the genomic data of the subject identifies a susceptibility of the subject to an intervention.

### Embodiment 50

The method of any one of embodiments 47-49, wherein the correlation between the additional clinical information and the genomic data of the subject identifies a resistance of the subject to a risk.

### Embodiment 51

The method of any one of embodiments 47-50, wherein the correlation between the additional clinical information and the genomic data of the subject identifies a resistance of the subject to an intervention.

### Embodiment 52

The method of any one of embodiments 47-51, further comprising recommending an intervention for the subject based on the report of the correlation between the additional clinical information and the genomic data of the subject.

### Embodiment 53

The method of any one of embodiments 47-52, further comprising receiving an alert, wherein the alert provides advice regarding the update of the electronic health record of the subject with the additional clinical information.

### Embodiment 54

The method of any one of embodiments 47-53, wherein the update of the additional clinical information into the electronic health record of the subject is prevented.

What is claimed is:

1. A method comprising:
a) receiving a search term;
b) identifying, based on the search term, a result clinical concept that is recognized by a first standardized ontological hierarchy;
c) identifying in a second standardized ontological hierarchy a corresponding clinical concept, wherein the corresponding clinical concept has a clinical meaning that is substantively-similar to the clinical meaning of the result clinical concept;
d) searching by a computer processor a database of electronic health records based on the corresponding clinical concept;
e) identifying an electronic health record in the database associated with the corresponding clinical concept; and
f) outputting a result.

2. The method of claim 1, further comprising identifying corresponding clinical concepts in at least 10 other standardized ontological hierarchies.

3. The method of claim 1, further comprising identifying a cohort of subjects that includes the corresponding clinical concept in the electronic health record of each subject of the cohort.

4. The method of claim 3, wherein the cohort includes a subject identified based on the first standardized ontological hierarchy and a subject identified based on the second standardized ontological hierarchy.

5. The method of claim 1, wherein the output result provides clinical decision support based on the search.

6. The method of claim 1, further comprising receiving instructions to create a rule based on the output result.

7. The method of claim 6, wherein the rule is activated when a user enters the search term or a term with a substantially-similar clinical meaning as the search term.

8. The method of claim 6, wherein the rule is activated when an electronic health record is updated.

9. The method of claim 6, wherein the rule alerts a user to a risk.

10. The method of claim 6, wherein the rule associates the search term with genomic information.
